(19) United States
(12) Patent Application Publication
(10) Pub. No.: US 2023/0333289 A1
(43) Pub. Date: Oct. 19, 2023

(54) Optical Construction and Optical System Including Light Absorbing Optical Cavity

(71) Applicant: 3M INNOVATIVE PROPERTIES COMPANY, St. Paul, MN (US)

(72) Inventors: Stephen P. Maki, North St. Paul, MN (US); Zhaohui Yang, North Oaks, MN (US); Przemyslaw P. Markowicz, Woodbury, MN (US); Mark A. Roehrig, Stillwater, MN (US); Tri D. Pham, Woodbury, MN (US); Serena L. Mollenhauer, Roberts, WI (US); David A. Rosen, North St. Paul, MN (US); Yang Liu, Woodbury, MN (US)

(21) Appl. No.: 18/024,946

(22) PCT Filed: Aug. 13, 2021
(86) PCT No.: PCT/IB2021/057486

§ 371 Date: Mar. 6, 2023

Related U.S. Application Data
(60) Provisional application No. 63/080,105, filed on Sep. 18, 2020.

(51) Int. Cl. G02B 3/00; G02B 5/00

(52) U.S. Cl. CPC G02B 3/0056; G02B 5/003; G02F 1/13338

(57) ABSTRACT

An optical construction can include a lens layer including microlenses formed on a substrate and at least one light absorbing optical cavity disposed on a substrate side of the lens layer. Each light absorbing optical cavity has an average thickness of less than about 300 nm and includes an optically transparent middle layer disposed between light absorbing first and second end layers. Each of the first and second end layers, but not the middle layer, defines a plurality of through openings therein aligned in a one-to-one correspondence with the microlenses. The optical construction can include an optically transparent spacer layer disposed between two light absorbing optical cavities. An optical system includes the optical construction and a refractive component including at least one prism film.

### BACKGROUND

An optical element can include microlenses and a pinhole mask having pinholes aligned with the microlenses.

A device including a liquid crystal display can include a fingerprint sensor behind the display.

### SUMMARY

The present description relates generally to an optical construction including a lens layer and at least one light absorbing optical cavity. An optical system can include the optical construction.

In some aspects of the present description, an optical construction is provided. The optical construction includes a lens layer including a plurality of microlenses formed on a substrate and arranged along orthogonal first and second directions. The optical construction further includes first and second light absorbing optical cavities disposed on the substrate side of the lens layer. Each light absorbing optical cavity has an average thickness of less than about 300 nm and includes an optically transparent middle layer disposed between light absorbing first and second end layers. Each of the first and second end layers, but not the middle layer, defines a plurality of through openings therein arranged along the first and second directions and aligned in a one-to-one correspondence with the microlenses. The optical construction further includes an optically transparent spacer layer disposed between the first and second light absorbing optical cavities and having an average thickness of greater than about 1 micrometer.

In some aspects of the present description, an optical construction is provided. The optical construction includes a lens layer including a plurality of microlenses arranged along orthogonal first and second directions and an optically opaque first mask layer spaced apart from the lens layer and defining a plurality of first optical openings therethrough arranged along the first and second directions. The first mask layer includes a first light absorbing optical cavity having an average thickness of less than about 300 nm and including an optically transparent middle layer disposed between light absorbing first and second end layers. Each first optical opening includes a through opening in each of the first and second end layers, but not in the middle layer. The optical construction further includes an optically opaque second mask layer spaced apart from the lens and first mask layers and defining a plurality of second optical openings therethrough arranged along the first and second directions. The first mask layer is disposed between the lens and the second mask layers. There is a one-to-one correspondence between the microlenses and the first and second optical openings, such that for each microlens, the microlens and corresponding first and second optical openings are substantially centered on a straight line making a same angle with the lens layer. When an image light carrying an image is incident on the microlens along the straight line such that the image light substantially fills the microlens, at least one of the first and second optical openings is sized so as to reduce an image quality degradation due to the microlens.

In some aspects of the present description, an optical construction including an integral optical layer is provided. The integral optical layer includes a structured first major surface and an opposite second major surface where the structured first major surface defines a plurality of microlenses arranged along orthogonal first and second directions. The integral optical layer further includes an embedded optically opaque first mask layer disposed between and spaced apart from the first and second major surfaces. The first mask layer defines a plurality of first optical openings therethrough arranged along the first and second directions. There is a one-to-one correspondence between the microlenses and the first optical openings. For each first optical opening in at least a majority of the first optical openings, the first optical opening defines a first voided region having a top major surface facing the first major surface and an opposite bottom major surface facing the second major surface. In a cross-section of the integral optical layer substantially perpendicular to the integral optical layer, the top and bottom major surfaces have a separation closer to a center of the first voided region greater than a separation closer to an edge of the first voided region. The first mask layer includes a light absorbing optical cavity having an average thickness of less than about 300 nm and including an optically transparent middle layer disposed between light absorbing first and second end layers. Each first optical opening includes a through opening in each of the first and second end layers, but not in the middle layer.

In some aspects of the present description, an optical construction including an integral optical layer is provided. The integral optical layer includes a structured first major surface and an opposite second major surface where the structured first major surface defines a plurality of microlenses arranged along orthogonal first and second directions. The integral optical layer further includes an embedded optically opaque first mask layer disposed between and spaced apart from the first and second major surfaces. The first mask layer defines a plurality of first optical openings therethrough arranged along the first and second directions. There is a one-to-one correspondence between the microlenses and the first optical openings. For each first optical opening in at least a majority of the first optical openings, the first optical opening defines a first voided region having a top major surface facing the first major surface and an opposite bottom major surface facing the second major surface. In a cross-section of the integral optical layer substantially perpendicular to the integral optical layer, the integral optical layer includes a plurality of nanoparticles concentrated along at least one of the top and bottom major surfaces of the first voided regions. The first mask layer includes a light absorbing optical cavity having an average thickness of less than about 300 nm and including an optically transparent middle layer disposed between light absorbing first and second end layers. Each first optical opening includes a through opening in each of the first and second end layers, but not in the middle layer.

In some aspects of the present description, an optical system including an optical construction described herein is provided. The optical construction includes a plurality of microlenses arranged along orthogonal first and second directions and includes at least one light absorbing optical cavity. The optical system further includes a liquid crystal display extending along the first and second directions; a lightguide disposed to illuminate the liquid crystal display; a refractive component disposed between the liquid crystal display and the lightguide where the refractive component includes a first prism film including a first plurality of prisms extending along a first longitudinal direction substantially parallel to a plane defined by the first and second directions; and an optical sensor disposed proximate the lightguide opposite the liquid crystal display. The optical construction is disposed between the lightguide and the optical sensor such that the microlenses face away from the optical sensor.

These and other aspects will be apparent from the following detailed description. In no event, however, should this brief summary be construed to limit the claimable subject matter.

### BRIEF DESCRIPTION OF THE DRAWINGS

FIGS. 1A-1D are schematic cross-sectional views of illustrative mask layers.

FIGS. 2A-2B are schematic cross-sectional views of illustrative optical constructions or layers.

FIGS. 3A-3C are schematic cross-sectional views of portions of illustrative optical constructions or layers showing a single microlens.

FIG. 4A is a schematic cross-sectional views of an illustrative optical construction or layer including two mask layers.

FIG. 4B is a schematic cross-sectional views of an illustrative multilayer mask.

FIG. 5 is a schematic cross-sectional views of an illustrative optical construction or layer including one mask layer.

FIG. 6 is a schematic cross-sectional view of an illustrative optical construction including an optical layer and a photosensor.

FIG. 7 is a schematic top projected view of an illustrative array of microlenses and optical openings.

FIGS. 8A-8C schematically illustrate light incident on a microlens.

FIG. 9 is a schematic plot of an illustrative intensity distribution of light transmitted through a microlens.

FIGS. 10A-10D are schematic cross-sectional views of portions of illustrative optical constructions or layers showing voided regions.

FIGS. 11-12 are schematic cross-sectional views of illustrative optical systems.

FIGS. 13A-13B are schematic views of maximum projected areas of illustrative optical constructions and refractive components.

FIG. 14 is a schematic cross-sectional view of an illustrative refractive component.

FIGS. 15A-15C are schematic illustrative conoscopic plots.

FIGS. 16-19 are plots of reflectance versus wavelength for various optical constructions.

FIGS. 20-22 are plots of calculated point spread functions for various optical constructions.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Mask layers including through openings (e.g., pinholes) in a metal layer can be used in an optical filter. However, the metal may cause undesired reflection. According to some embodiments of the present description, a mask layer including at least one light absorbing optical cavity is provided. Alternatively, an optical construction or layer can be described as having a mask layer replaced by a light absorbing cavity disposed between two end layers, according to some embodiments. It has been found that the light absorbing optical cavity substantially reduces unwanted reflections that would otherwise occur from the mask layer. In some embodiments, an optical construction or optical layer includes a microlens array and at least one light absorbing optical cavity having optical openings therethrough. Optical constructions or optical layers described herein may be used as angle selective optical filters, according to some embodiments. By reducing undesired reflection from the mask layer, it has been found that undesired cross-talk (e.g., where light incident on one microlens is transmitted through an opening corresponding to another microlens) can be substantially reduced, according to some embodiments.

For some applications, such as smartphone or tablet computer applications, it is desired to place a fingerprint sensor behind a liquid crystal display (LCD). However, liquid crystal displays often include a refractive component, such as crossed prism films, behind a liquid crystal display panel. Light reflected from a fingerprint is typically split into multiple beam segments by the refractive component and this can reduce the quality of the optical image of the fingerprint when incident on the sensor. According to some embodiments, optical constructions, layers, and systems which avoid or substantially reduce this image quality reduction are provided.

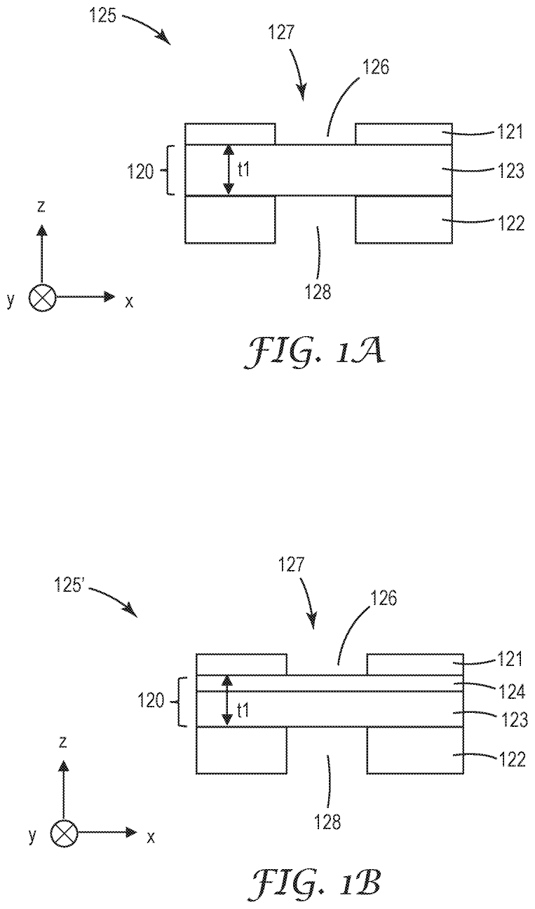

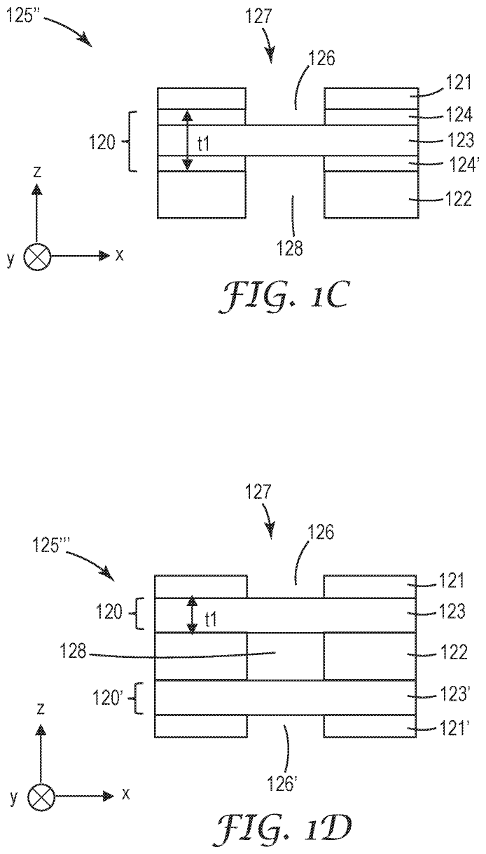

FIGS. 1A-1D are schematic cross-sectional views of portions of mask layers 125, 125′, 125″, and 125′″, respectively, according to some embodiments. In FIG. 1A, the mask layer 125 includes a light absorbing optical cavity 120 including an optically transparent middle layer 123 disposed between light absorbing first and second end layers 121 and 122. The optically transparent middle layer 123, and/or other optically transparent middle layers described elsewhere, can be a polymeric layer or an inorganic dielectric layer, for example. In some embodiments, the middle layer can have a high refractive index (e.g., at least about 1.7, or at least about 2.0, at a wavelength of 532 nm). Suitable high index materials include TiO₂, Ge, and Si, for example. Each of the first and second end layers 121 and 122, but not the middle layer 123, defines a plurality of through openings 126 and 128, respectively, therein (only one through opening is shown in each of the first and second end layers 121 and 122 in the illustrated portion of the mask layer 125). Each through opening 126 and corresponding through opening 128 define an optical opening 127 through the mask layer 125. The optical cavity 120 can optionally include a layer 124 between the middle layer 123 and the first end layer 121 (see, e.g., FIG. 1B) and/or can include a layer 124′ between the middle layer 123 and the second end layer 122 (see, e.g., FIG. 1C). For the mask layers 125′ and 125″, the optical opening 127 includes a through opening 126 through the first end layer 121 and through the layer 124. For the mask layer 125″, the optical opening 127 includes a through opening 128 through the second end layer 122 and through the layer 124′. The layers 124, 124′ may be included as tie layers to improve adhesion between the middle layer 123 and an adjacent layer.

An end layer can be described as light absorbing when the end layer absorbs at least about 5% of substantially normally incident light for at least one wavelength in a range of about 400 nm to about 1100 nm, for example. The optical absorbance, transmittance and reflectance specified for an end layer can be understood to be for the end layer immersed in air, unless otherwise indicated. In some embodiments, each end layer of a light absorbing optical cavity absorbs at least 10% of substantially normally incident light for at least one wavelength in a range of about 400 nm to about 1100 nm. In some embodiments, at least one end layer (e.g., first end layer 121) of a light absorbing optical cavity absorbs at least 20% or at least 25% of substantially normally incident light for at least one wavelength in a range of about 400 nm to about 1100 nm.

Any of the light absorbing optical cavities described herein can be optically absorbing (e.g., optical absorption of at least 10% or at least 20% or at least 30% for substantially normally incident light incident on the first end layer 121) over a wavelength range extending at least from about 450 nm to about 650 nm, or at least about 450 nm to about 1100 nm, or at least about 400 nm to about 650 nm, or at least about 400 nm to about 1100 nm, for example. Any of the light absorbing optical cavities described herein can be optically absorbing at a laser wavelength used to ablate though openings in the end layers. The end layers (e.g., 121 and 122) may define a light absorbing interference cavity where light incident on an end layer is partially absorbed and partially reflected. In some embodiments, the first end layer 121 has a higher average optical transmittance and/or a higher average optical absorbance than the second end layer 122 for substantially normally incident light in a wavelength range extending at least from about 450 nm to about 650 nm. In some embodiments, the second end layer 122 has a higher optical reflectance than the first end layer 121 for substantially normally incident light in a wavelength range extending at least from about 450 nm to about 650 nm.

As used herein, an optically transparent layer is a layer having an average optical transmittance for substantially normally incident light in a wavelength range extending from about 450 nm to about 650 of greater than 50%. In some embodiments, the optically transparent middle layer 123 has an average optical transmittance of substantially normally incident light in a wavelength range extending at least from about 450 nm to about 650 nm of at least 60%, or at least 80%, or at least 90%. In some embodiments, the optically transparent middle layer 123 has an average optical transmittance of substantially normally incident light in a wavelength range extending at least from about 450 nm to about 1100 nm of greater than 50%, or at least 60%, or at least 80%, or at least 90%. A layer described as optically transparent may be partially optically absorptive. In some embodiments, the optically transparent middle layer 123 is a polymeric layer including dyes or pigments so that the optically transparent middle layer 123 has an optical absorption of about 1% to about 30% or to about 20% for substantially normally incident light in a wavelength range extending at least from about 450 nm to about 650 nm or at least from about 450 nm to about 1100 nm.

Any of the light absorbing optical cavities described herein can optionally include other layers between the first and second end layers. Other layers known in the art to be useful in a light absorbing optical cavity may also be included. In some embodiments, the light absorbing optical cavity is a compound cavity including an additional metal layer disposed between the first and second end layers with dielectric layers (e.g., optically transparent polymeric layers) disposed between the additional metal layer and each of the first and second end layers, for example.

A through opening in a layer is an opening where material has been removed from the layer so that a physical opening through the layer is present. For example, physical openings or holes can be formed in a light absorbing layer (e.g., layer 121, 122, and/or 124) by laser ablation. Through openings may be referred to as physical openings or physical through openings. Optical openings through a layer are such that light can be transmitted through the layer through the optical openings. Optical openings can be physical through openings or can have material treated so that light can be transmitted through the optical openings even if material is present in the optical openings. For example, optical openings can be formed in a light absorbing layer by bleaching (e.g., an optically opaque layer incorporating dyes can be photobleached or thermobleached such that the bleached dyes are no longer optically absorptive). Optical openings can be formed in a birefringent reflective film by reducing birefringence in the openings as generally described in U.S. Pat. No. 9,575,233 (Merrill et al.), for example. An absorption overcoat can optionally be applied to the optical film to increase the absorption of energy from the laser. In some embodiments, optical openings through a multilayer mask includes physical through openings in some, but not all, of the layers. For example, the optical openings 127 in the mask layer 125 includes through openings 126 and 128 defined in first and second end layers 121 and 122, respectively, but does not include through openings in the optically transparent middle layer 123.

In FIG. 1D, the mask layer 125′″ includes first and second light absorbing optical cavities 120 and 120′. Each light absorbing optical cavity 120, 120′ includes an optically transparent (e.g., polymeric) middle layer 123, 123′ disposed between light absorbing first (121, 121′) and second (122) end layers. The layer 122 is a second end layer for each of the optical cavities 120 and 120′. The optical opening 127 includes through openings 126, 126′ and 128 in the layers 121, 121′ and 122, respectively, but does not include a through opening in layers 123 or 123′. The optical cavity 120 may include a layer corresponding to layer 124 or 124′ between the first end layer 121 and the middle layer 123 and/or between the middle layer 123 and the second end layer 122. Similarly, the optical cavity 120′ may include a layer corresponding to layer 124 or 124′ between the first end layer 121′ and the middle layer 123′ and/or between the middle layer 123′ and the second end layer 122.

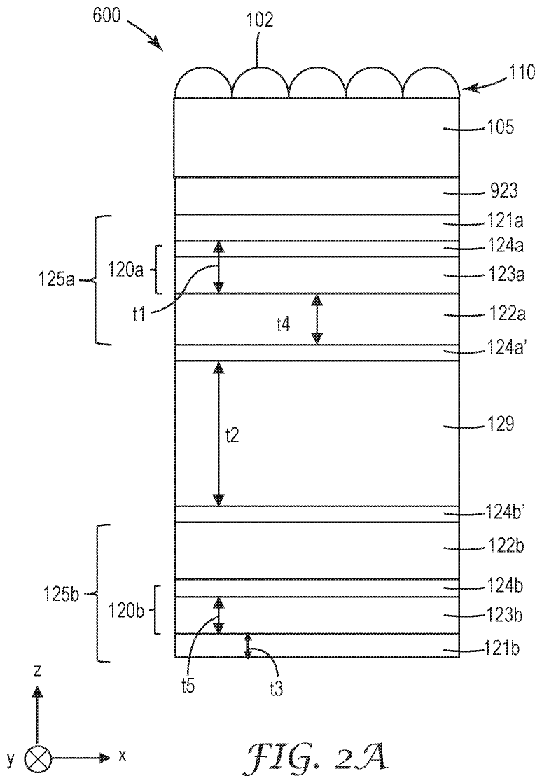

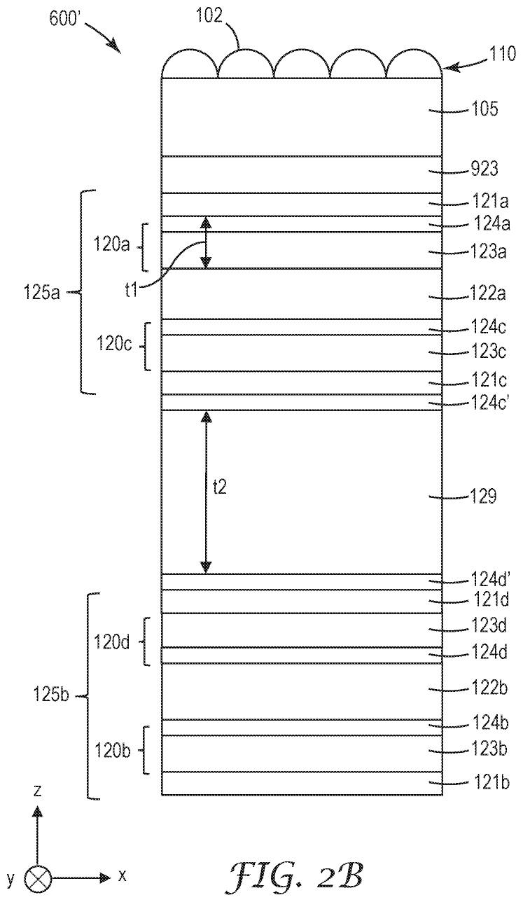

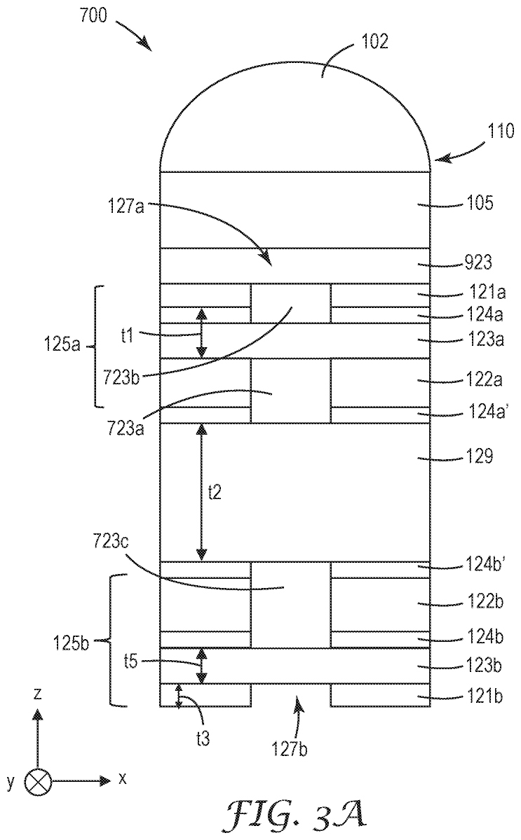

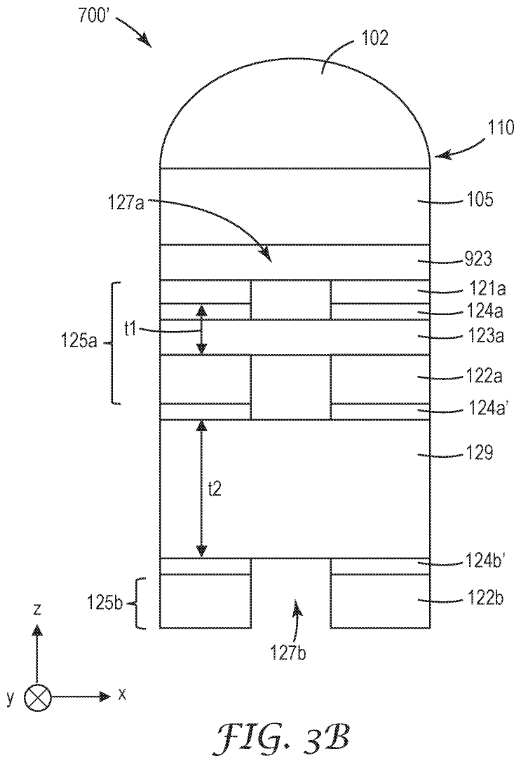

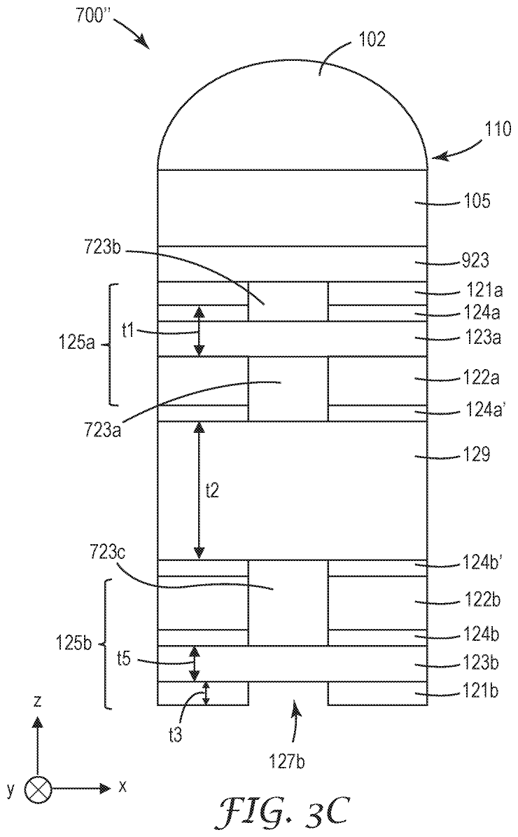

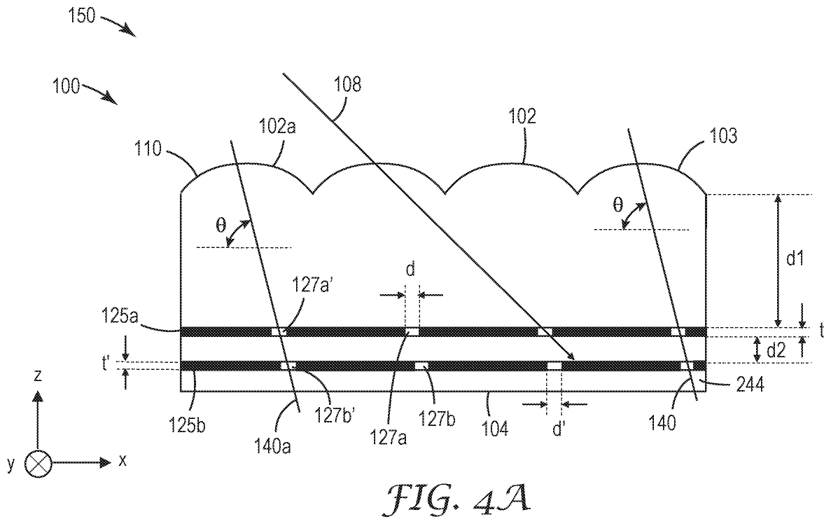

FIGS. 2A-2B are schematic cross-sectional views of optical constructions 600 and 600′, respectively, according to some embodiments. FIGS. 3A-3C are schematic cross-sectional views of portions of optical constructions 700, 700′,700″, respectively, according to some embodiments, where the illustrated portion includes a single microlens 102. Optical construction 700 can correspond to optical construction 600, for example. Optical construction 700″ can correspond to optical construction 700, for example, except that the through openings are arranged generally along a line making an oblique angle relative to a plane of the optical construction, as described further elsewhere. In some embodiments, the optical constructions 600, 600′, 700, 700, and/or 700″ may be described as including optically opaque mask layers 125a and 125b. The optically opaque mask layers 125a and 125b include respective optical openings 127a and 127b therethrough (see, e.g., FIGS. 3A-3C; the openings are not shown in FIGS. 2A-2B for ease of illustration). In some embodiments, the optical constructions 600, 600′, 700, 700, and/or 700″ are integral optical layers as described further elsewhere.

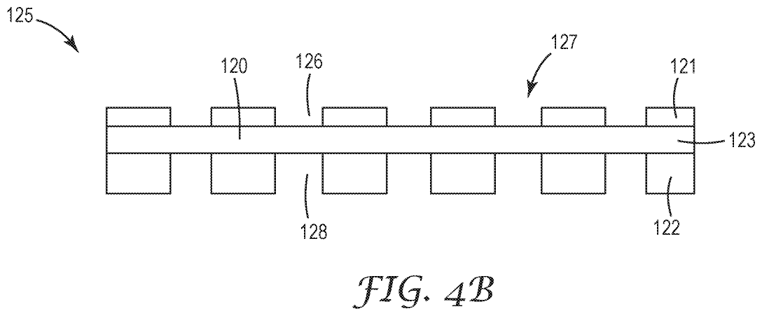

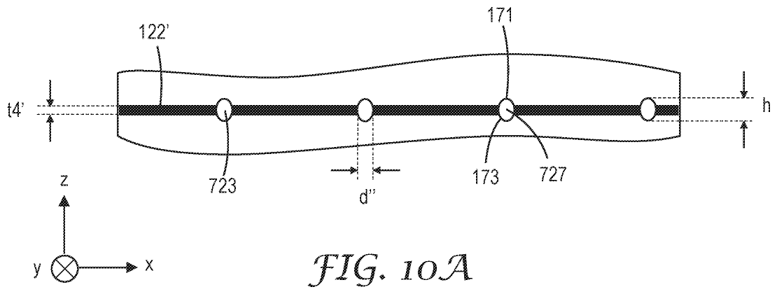

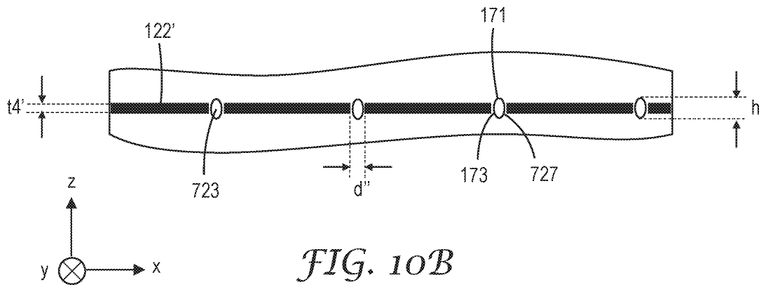

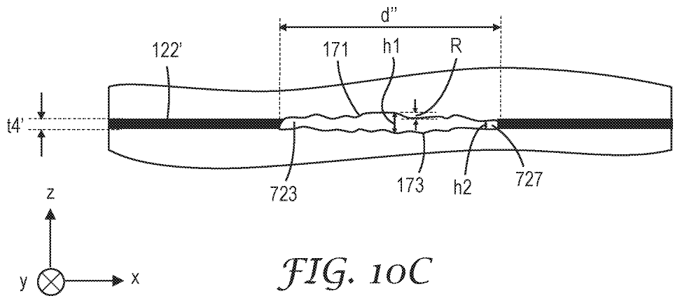

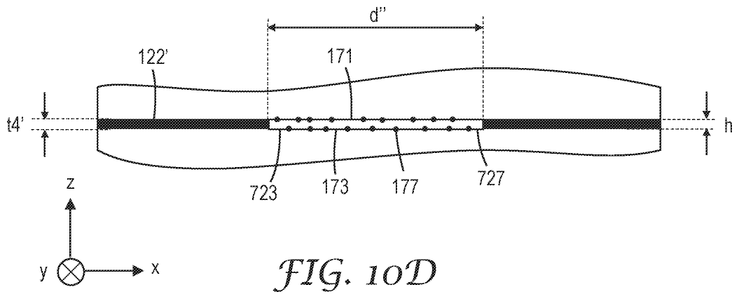

In some embodiments, the optical construction 600, 600′ includes a lens layer 110 including a plurality of microlenses 102 formed on a substrate 105 and arranged along orthogonal first and second directions (e.g., along x- and y-directions referring to the illustrated x-y-z coordinate system); first and second light absorbing optical cavities 120a and 120b disposed on the substrate side of the lens layer where each light absorbing optical cavity has an average thickness t1 of less than about 300 nm and includes an optically transparent (e.g., polymeric) middle layer 123a, 123b disposed between light absorbing first (121a, 121b) and second (122a, 122b) end layers; and an optically transparent spacer layer 129 disposed between the first and second light absorbing optical cavities 120a, 120b and having an average thickness t2 of greater than about 1 micrometer. Each of the first and second end layers, but not the middle layer, defines a plurality of through openings 126, 128 therein (see, e.g., FIGS. 1A-1D) arranged along the first and second directions and aligned in a one-to-one correspondence with the microlenses (see, e.g., FIGS. 4 and 10). In some embodiments, an optical construction includes only one light absorbing optical cavity (see, e.g., FIG. 3B) while in other embodiments, an optical construction includes two or more light absorbing optical cavities. For example, the optical construction 600′ schematically illustrated in FIG. 2B includes light absorbing optical cavities 120a, 120b, 120c and 120d. One of the light absorbing optical cavities 120a and 120c can be regarded as a first light absorbing optical cavity separated from a second light absorbing optical cavity by the optically transparent spacer layer 129 where one of light absorbing optical cavities 120d and 120b can be regarded as the second light absorbing optical cavity. The two other light absorbing optical cavities can be regarded as third and fourth light absorbing optical cavities separated by the optically transparent spacer layer 129. Accordingly, in some embodiments, an optical construction that includes first and second light absorbing optical cavities further includes third and fourth light absorbing optical cavities disposed on the substrate side of the lens layer, the optically transparent spacer layer being disposed between the third and fourth light absorbing optical cavities, where for each of the third and fourth light absorbing optical cavities, the optical cavity has an average thickness of less than about 300 nm and includes an optically transparent middle layer disposed between light absorbing first and second end layers, each of the first and second end layers, but not the middle layer, defining a plurality of through openings therein arranged along the first and second directions and aligned in a one-to-one correspondence with the microlenses. A mask layer may include two light absorbing optical cavities when it is desired to reduce reflection of light incident on either side of the mask layer. Including four light absorbing optical cavities as schematically illustrated in FIG. 2B for optical construction 600′ can result in reduced reflection of light incident on the optical construction 600′ from the microlens side of the substrate 105 and from the opposite side of the substrate 105 and can reduce reflections between the two mask layers. Such reflections could otherwise result in undesired cross-talk.

In some embodiments, the optically transparent spacer layer 129 has an average optical transmittance of substantially normally incident light in a wavelength range extending at least from about 450 nm to about 650 nm of at least 60%, or at least 80%, or at least 90%. In some embodiments, the optically transparent spacer layer 129 is a polymeric layer such as an acrylate layer, for example.

In some embodiments, the first end layers (e.g., 121c and 121d) of the first and second light absorbing optical cavities (e.g., 120c and 120d) face each other, and the second end layers (e.g., 122a and 122b) of the first and second light absorbing optical cavities (e.g., 120c and 120d) face away from each other. In some embodiments, the second end layers (e.g., 122a and 122b) of the first and second light absorbing optical cavities (e.g., 120a and 120b) face each other, and the first end layers (e.g., 121a and 121b) of the first and second light absorbing optical cavities (e.g., 120a and 120b) face away from each other.

The light absorbing optical cavities 120a, 120b, 120c and 120d include optically transparent (e.g., polymeric) middle layers 123a, 123b, 123c, 123d, respectively, disposed between respective light absorbing first (121a, 121b, 121c, 121d) and second (122a, 122b, 122a, 122b) end layers, where each of layers 122a and 122b is an end layer for two of the optical cavities. Any of the optical cavities may include an additional layer (e.g., a tie layer) between the middle layer and an end layer (e.g., additional layers 124a, 124a′, 124b and 124b′ illustrated in FIG. 2A and/or additional layers 124a, 124b, 124c, 124c′, 124d, and 124d′ illustrated in FIG. 2B). The additional layer(s) can include an alloy of a metal of the second end layer (e.g., 122a, 122b), for example. In some embodiments, at least one of the first and second light absorbing optical cavities (e.g., 120a and/or 120b) further includes an alloy (e.g., in layer 124a) of the second end layer (e.g., 122a) disposed between the first end layer (e.g., 121a) and the middle layer (e.g., 123a). Such additional layer(s) can be useful for improving bonding to the middle layer when the middle layer is a polymeric layer, for example. Such additional layer(s) can be useful for improving bonding to the middle layer when the middle layer is a polymeric layer, for example. In some embodiments, the second end layer is or includes aluminum. In some embodiments, the alloy is or includes SiAlOx, for example. In some embodiments, an alloy (e.g., in layer 124a′ and/or 124b′ in FIG. 3A) of the second end layer (e.g., 122a) is disposed between the spacer layer 129 and the second end layer (e.g., 122a, 122b) of each of the first and second light absorbing optical cavities (e.g., 120a, 120b). This alloy may be or include SiAlOx, for example. In some embodiments, each of the additional layer(s) has an average thickness less than about 15 nm, or less than about 10 nm, or less than about 8 nm. The average thickness can be at least about 0.5 nm or at least about 1 nm, for example. The additional layer(s) may be formed by reactive sputtering in an Ar/O₂ plasma from aluminum and silicon sources.

In some embodiments, an optical construction includes first and second optically opaque mask layers 125a and 125b, where at least one of the mask layers 125a, 125b includes a light absorbing optical cavity including an optically transparent middle layer disposed between light absorbing first and second end layers. For example, in the embodiment illustrated in FIG. 3B, the first mask layer 125a, but not the second mask layer 125b, includes a light absorbing optical cavity.

In some embodiments, the first and second end layers are each metallic layers. The metal for a first end layer, for example, can be chosen to have a suitable refractive index and extinction coefficient. Suitable materials for a first end layer (e.g., 121a or 121b) of a light absorbing optical cavity include titanium, chromium, nickel, or an alloy thereof. Suitable materials for a second end layer (e.g., 122a or 122b) of a light absorbing optical cavity include aluminum, silver, indium, tin, tungsten, gold, or an alloy thereof. In some embodiments, the light absorbing first end layer (e.g., 121a, 121b) of each of the first and second light absorbing optical cavities (e.g., 120a and 120b) includes titanium, chromium, nickel, or an alloy thereof. In some embodiments, the light absorbing first end layer (e.g., 121a, 121b) of each of the first and second light absorbing optical cavities (e.g., 120a and 120b) includes titanium. In some such embodiments, or in other embodiments, the light absorbing first end layer (e.g., 121a, 121b) of each of the first and second light absorbing optical cavities (e.g., 120a and 120b) has an average thickness t3 of less than about 30 nm, or less than about 25 nm, or less than about 20 nm, or less than about 15 nm. The average thickness t3 can be greater than about 4 nm or greater than about 6 nm, for example. In some embodiments, the light absorbing second end layer (e.g., 122a, 122b) of each of the first and second light absorbing optical cavities (e.g., 120a and 120b) includes aluminum, silver, indium, tin, tungsten, gold, or an alloy thereof. In some embodiments, the light absorbing second end layer (e.g., 122a, 122b) of each of the first and second light absorbing optical cavities (e.g., 120a and 120b) includes aluminum. In some such embodiments, or in other embodiments, the light absorbing second end layer (e.g., 122a, 122b) of each of the first and second light absorbing optical cavities (e.g., 120a and 120b) has an average thickness t4 of less than about 50 nm, or less than about 45 nm, or less than about 40 nm, or less than about 35 nm. The average thickness t4 can be greater than about 15 nm or greater than about 20 nm, for example.

In some embodiments, the optically transparent middle layer (e.g., 123a, 123b) of each of the first and second light absorbing optical cavities is or includes an acrylate. In some such embodiments, or in other embodiments, the optically transparent middle layer (e.g., 123a, 123b) of each of the first and second light absorbing optical cavities has an average thickness t5 of less than about 300 nm, or less than about 250 nm, or less than about 200 nm, or less than about 150 nm, or less than about 120 nm. The average thickness t5 can be greater than about 40 nm, or greater than about 50 nm, or greater than about 60 nm, for example. The average thickness t1 of the light absorbing optical cavity (e.g., 120a, 120b) can be less than about 300 nm, or less than about 250 nm, or less than about 200 nm, or less than about 150 nm, or less than about 120 nm, for example. The average thickness t1 can be greater than about 40 nm, or greater than about 50 nm, or greater than about 60 nm, for example. An average thickness t5 that is too large can result in undesired visible color while an average thickness t1 that is too small can result in reduced optical absorption in the desired (e.g., visible) wavelength range. Accordingly, in some embodiments, the average thickness t5 is less than about 120 nm and the average thickness t1 is greater than about 50 nm. The average thickness t2 of the spacer layer 129 can be greater than about 1 micrometer, or greater than about 1.5 micrometers, or greater than about 2 micrometers, for example. The average thickness t2 can be less than about 10 micrometers or less than about 8 micrometers, for example.

Optional additional polymeric layer 923 can be disposed between the substrate 105 and the first end layer 121a. The additional polymeric layer 923 may be included for improved bonding of the first end layer 121a to the substrate 105, for example. In some embodiments, the additional layer 923 has an average thickness in a range described for middle layer (e.g., 123a), for example. In some embodiments, the additional layer 923 is an acrylate layer.

Suitable materials for an acylate layer (e.g., an optically transparent middle layer 123a or 123b, or an additional polymeric layer 923, or an optically transparent spacer layer 129) include radiation cured compositions. Suitable compositions can be formed from SR833S, a difunctional acrylate monomer available from Sartomer (Exton, PA), with appropriate curing agent(s) and optionally other additives as would be appreciated by a person of ordinary skill in the art.

As described further elsewhere (see, e.g., FIG. 4A), in some embodiments, the optical construction includes an optically opaque first mask layer 125a defining a plurality of first optical openings 127a therethrough and an optically opaque second mask layer 125b defining a plurality of second optical openings 125b therethrough. In some embodiments, for each first optical opening in at least a majority of the first optical openings 127a, the first optical opening defines at least one voided region. For example, the first optical opening 127a depicted in FIG. 3A defines a first voided region 723a extending at least through end layer 122a and a second voided region 723b extending at least through end layer 121a. In some embodiments, for each first optical opening in the at least the majority of the first optical openings: the first voided region extends through a thickness of the second end layer; and the first optical opening defines a second voided region extending through a thickness of the first end layer. In some embodiments, an additional layer 244 (see, e.g., FIG. 4A) is disposed on the second mask layer 125b opposite the first mask layer 125a. In other embodiments, the additional layer 244 is omitted. In some embodiments, for each second optical opening in at least a majority of the second optical openings 127b, the second optical opening defines at least one voided region. For example, the second optical opening 127b depicted in FIG. 3A defines a first voided region 723c extending at least through end layer 122b and, if additional layer 244 were included, would define a second voided region extending at least through end layer 121b between layer 123b and layer 244. In some embodiments, for each second optical opening in the at least the majority of the second optical openings: the first voided region extends through a thickness of the second end layer; and the second optical opening defines a second voided region extending through a thickness of the first end layer.

An optical construction can have a first major surface defining the microlenses 102 and can have an opposite second major surface. A voided region can have a top major surface facing the first major surface and an opposite bottom major surface facing the second major surface. The optical construction can be or include an integral optical layer as described further elsewhere. In some embodiments, in at least one cross-section of the integral optical layer substantially perpendicular (e.g., within 30 degrees, or within 20 degrees, or within 10 degrees of perpendicular) to the integral optical layer, the integral optical layer includes a plurality of nanoparticles concentrated along at least one of the top and bottom major surfaces of the voided regions, as described further elsewhere. Here, the voided regions may refer to the first and/or second voided regions defined by the first optical openings and/or the first and/or second voided regions defined by the second optical openings. In some embodiments, in a cross-section of the integral optical layer substantially perpendicular to the integral optical layer (e.g., in a cross-section containing the z-axis), the top and bottom surfaces have a separation closer to a center of the voided region greater than a separation closer to an edge of the voided region. In some such embodiments or in other embodiments, at least one of the top and bottom major surfaces has a surface roughness in a range of 10 nm to 200 nm or in a range described elsewhere.

Spatially related terms, including but not limited to, “top” and “bottom” are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

FIG. 4A is a schematic cross-sectional view of an optical system 150 including a lens layer 110, an optically opaque first mask layer 125a, and an optically opaque second mask layer 125b. In some embodiments, an optical construction or layer 100 includes each of the lens layer 110 and the first and second mask layers 125a and 125b. The optical construction or layer 100 can have a structured first major surface 103 and an opposite second major surface 104. In other embodiments, different optical constructions or elements may include one or more of the different layers. For example, a first optical construction or element may include the lens layer 110 and the first mask layer 125a, and a second optical construction or element spaced apart from the first optical construction or element may include the second mask layer 125b.

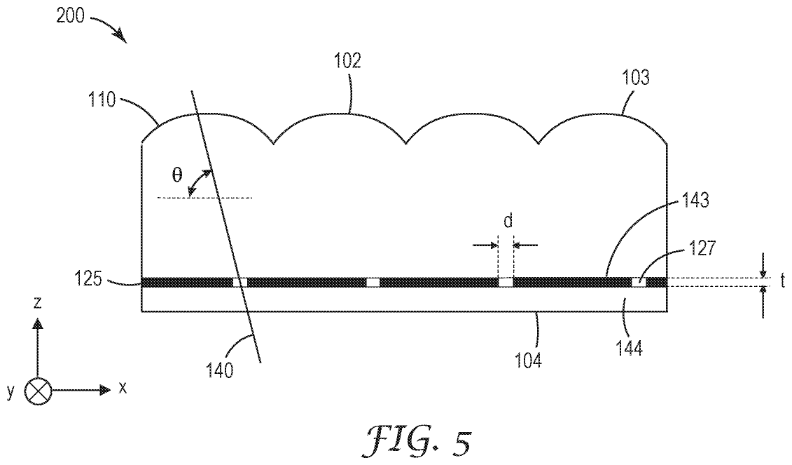

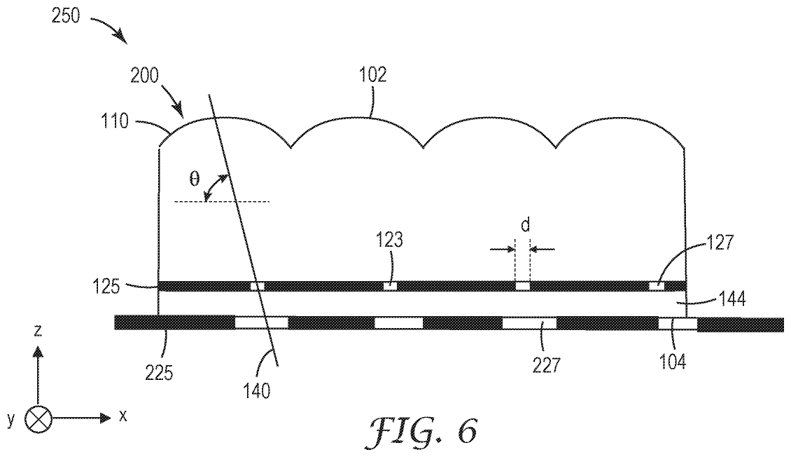

The lens layer 110 includes a plurality of microlenses 102 arranged (e.g., in a regular array) along orthogonal first and second directions (e.g., x- and y-directions). The microlenses 102 can be formed on a substrate 105 as described elsewhere. The optically opaque first mask layer 125a is spaced apart from the lens layer 110 by a distance d1, which can be in a range of 2 to 35 micrometers, for example. The optically opaque first mask layer 125a defines a plurality of first optical openings 127a therethrough arranged along the first and second directions. The optically opaque second mask layer 125b is spaced apart from the lens and first mask layers 110 and 125a and defines a plurality of second optical openings 127b therethrough arranged along the first and second directions. While only a single layer is illustrated for each of the mask layers 125a and 125b schematically shown in FIG. 4A (and similarly in FIGS. 5-6 for mask layer 125), it will be understood that the mask layer can be a multilayer mask. FIG. 4B is a schematic cross-sectional view of a mask layer 125, according to some embodiments, which may be described as a multilayer mask and which may correspond to some embodiments of the mask layer 125a and/or 125b of FIG. 4A. The mask layer 125a and/or the mask layer 125b of the embodiment of FIG. 4A can be as described for any of the mask layers of any of the embodiments of FIG. 1A to 3C or 4B. For example, the mask layer 125a and/or 125b can include a light absorbing optical cavity (e.g., 120) including a middle layer (e.g., 123) disposed between first (e.g., 121) and second (e.g., 122) end layers and the respective optical openings 127a and/or 127b can include through openings (e.g., 126 and 128) defined in the first and second end layers, but not the middle layer.

The first mask layer 125a is disposed between the lens and second mask layers 110 and 125b. The second mask layer 125b is spaced apart from the first mask layer 125a by a distance d2 which can be in a range of 1 to 20 micrometers, for example. The distance d2 can be the thickness t2 plus the thickness of tie layer(s), if included, between a mask layer and a spacer layer (e.g., layer 129), for example. Alternatively, the distance d2 can be the thickness t2 (e.g., the mask layer can be considered to include the tie layer(s), if present, adjacent to the layer 129). In some embodiments, d2<d1, or d2<0.7 d1, or d2<0.5 d1. There can be a one-to-one correspondence between the microlenses 102 and the first and second optical openings 127a and 127b (i.e., for each microlens 102, one first optical opening 127a and one second optical opening 127b corresponds to the microlens), such that for each microlens 102, the microlens and corresponding first and second optical openings 127a and 127b are substantially centered on a straight line 140 making a same oblique angle θ with the lens layer 110. For example, microlens 102a corresponds to first and second optical openings 127a′ and 127b′ and the microlens 102a and the corresponding first and second openings 127a′ and 127b′ are substantially centered on a straight line 140a. In some embodiments, for each microlens in at least a majority of the microlenses, the microlens and corresponding through openings in in the first and second end layers of each of the first and second light absorbing optical cavities are substantially centered on a straight line making a same angle θ with the lens layer. The angle θ can be an oblique angle as schematically illustrated in FIGS. 3C and 4-6, for example, or can be about 90 degrees corresponding to normal incidence (see, e.g., FIGS. 3A-3B). The oblique angle can be in a range of about 10 degrees to about 80 degrees, or about 20 degrees to about 65 degrees, or about 30 degrees to about 50 degrees, for example. A lens or opening can be described as substantially centered on the straight line 140 when the line passes through a center of the lens or opening or passes through the center to within about 20 percent, or within about 10 percent, or within about 5 percent of a diameter of the lens or opening, respectively, for example.

A microlens is generally a lens with at least two orthogonal dimensions (e.g., a height and a diameter, or a diameter along two axes) less than 1 mm and greater than 100 nm. The microlenses can have an average diameter in a range of 10 micrometers to 100 micrometers, for example. The microlenses can have an average radius of curvature in a range of 5 micrometers to 50 micrometers, for example. The microlenses can be spherical or aspherical microlenses, for example. It has been found that aspherical microlenses can provide improved optical properties (e.g., improved focus) for light incident at a desired off-axis angle (e.g., along the lines 140). The optical construction or layer 100, or other optical constructions or layers described elsewhere herein, can have a total thickness in a range of 10 micrometers to 100 micrometers, for example.

A mask layer can be described as optically opaque when less than 20%, or less than 15%, or less than 10%, or less than 5%, or less than 3%, or less than 1% of unpolarized visible light normally incident on the layer in a region between openings is transmitted through the layer. A mask layer can be optically absorptive or optically reflective. Preferably, at least one mask layer is optically absorptive due, at least in part, to including an optically absorptive optical cavity. In some embodiments, the first mask layer 125a includes an optically absorptive optical cavity and the second mask layer 125b includes one or more of an optically absorptive optical cavity, a metal layer (e.g., vapor deposited or sputtered), a metal oxide layer, a dark material (e.g., including optically absorptive dye(s)) coating, and an optically absorptive or reflective film, for example. The mask layers, for example, can a sufficient thickness for the material to be suitably optically opaque (e.g., a metal layer having a thickness of at least about 15 nm, or at least about 20 nm, or at least about 25 nm), for example. In some embodiments, the average thicknesses t and t′ of the mask layers may each be in a range of 5 nm to 5 micrometers. In some embodiments, t and/or t′ is in a range of 10 nm to 500 nm, or 20 nm to 300 nm, or 40 nm to 250 nm, or 60 nm to 200 nm, for example.

The first and second mask layers 125a and 125b can be included to limit light transmitted through the optical construction to substantially only light along the line 140. The second mask layer 125b can be included to reduce cross-talk where light incident on one microlens is transmitted through an opening corresponding to another microlens. For example, light ray 108 which would have otherwise resulted in cross-talk is blocked by the second mask layer 125b. In some embodiments, the second mask layer 125b is omitted. In some embodiments, a pixelated photosensor can be used instead of the second mask layer 125b as described further elsewhere herein. Related optical constructions are described in International Appl. Pub. No. WO 2020/035768 (Yang et al.) and in U.S. Appl. No. 62/944,676 filed Dec. 6, 2019 and titled “Optical Layer and Optical System”.

In some embodiments, the first optical openings 127a have an average diameter d in a range of 500 nm to 50 micrometers, or 1 micrometer to 40 micrometers, or 2 micrometers to 30 micrometers, or 3 micrometers to 20 micrometers, or 5 micrometers to 15 micrometers, for example. In some embodiments, the second optical openings 127b have an average diameter d′ in a range of 500 nm to 50 micrometers, or 1 micrometer to 40 micrometers, or 2 micrometers to 30 micrometers, or 3 micrometers to 20 micrometers, or 5 micrometers to 15 micrometers, for example. The diameter of an optical opening can be understood to be the diameter of a circle having the same area as the optical opening viewed along line 140.

In some embodiments, each sublayer (e.g., lens layer 110, first and second mask layers 125a and 125b) of an optical construction is bonded to an adjacent layer of the optical construction. In such embodiments, the optical construction may be referred to as an optical layer or an integral optical layer. An integral optical layer may be integrally formed or may be formed as discrete elements that are subsequently bonded to one another. In some embodiments, the integral optical layer is integrally formed. As used herein, a first element “integrally formed” with a second element means that the first and second elements are manufactured together rather than manufactured separately and then subsequently joined. Integrally formed includes manufacturing a first element followed by manufacturing the second element on the first element. For example, an integrally formed optical layer can made by manufacturing a lens layer 110 on a substrate 105 (e.g., in a cast and cure process) and then sequentially depositing (e.g., vapor depositing) the layers shown in FIG. 2A or 2B, for example, on the substrate 105 opposite the lens layer 110, and then laser ablating openings in the mask layers through the microlenses 102. Alternatively, the lens layer 110 can be formed on the substrate 105 after the other layers shown in FIG. 2A or 2B, for example, are deposited on the substrate 105. In some embodiments, the first mask layer 125a is embedded in the optical layer. In some embodiments, an additional layer 244 is disposed on the second mask layer 125b opposite the first mask layer 125a such that the second mask layer 125b is also an embedded layer. In some embodiments, the second mask layer 125b can be omitted. An embedded mask layer may include multiple layers (e.g., a middle layer disposed between two optically absorptive end layers) as described further elsewhere. In some embodiments, an optical construction includes an integral optical layer and optionally further includes one or more additional layers or elements.

FIG. 5 is a schematic cross-sectional view of optical construction or layer 200. In some embodiments, the optical construction or layer 200 includes a structured first major surface 103 and an opposite second major surface 104, where the structured first major surface 103 defines a plurality of microlenses 102 arranged along orthogonal first and second directions (e.g., x- and y-directions). The optical construction or layer 200, which may be an integrally formed optical layer, further includes an embedded optically opaque first mask layer 125 (e.g., corresponding to first mask layer 125a described elsewhere and/or corresponding to any of mask layers 125, 125′, 125″, or 125′″ illustrated in FIGS. 1A-1D, respectively) disposed between and spaced apart from the first and second major surfaces 103 and 104. The first mask layer 125 can be embedded between the lens substrate (e.g., corresponding to substrate 105) and an additional layer 144. The first mask layer 125 defines a plurality of first optical openings 127 therein arranged along the first and second directions. As described further elsewhere, the first mask layer 125 can include one or more light absorbing optical cavities, where each optical cavity includes a middle layer disposed between first and second end layers. The first optical openings can include through openings in the first and second end layers while not including through openings in the middle layer (see, e.g., FIG. 4B). There can be a one-to-one correspondence between the microlenses and the first optical openings. In some embodiments, for each first optical opening in at least a majority of the first optical openings 127, the first optical opening defines a voided region (e.g., voided region 723a and/or 723b).

In some embodiments, an optical construction or layer is used with a photosensor. In some such embodiments, the second mask layer may be omitted since sensor pixels of the photosensor and be aligned with the microlenses and with optical openings in a first mask layer. FIG. 6 is a schematic cross-sectional view of the optical construction or layer 200 disposed on a photosensor 225. In some embodiments, an optical construction 250 includes the integral optical layer 200, which may be integrally formed, and a photosensor 225 including a plurality of sensor pixels 227. In some embodiments, there is a one-to-one correspondence between the microlenses 102 and the sensor pixels 227, such that for each microlens in at least a majority of the microlenses 102, the microlens 102 and corresponding first optical openings 127 and sensor pixels 227 are substantially centered on a straight line 140 making a same (e.g., oblique) angle θ with the mask layer 125. The mask layer 125 of FIGS. 5 and/or 6 can be as described for any of the mask layers of FIG. 1A to 3C or 4B.

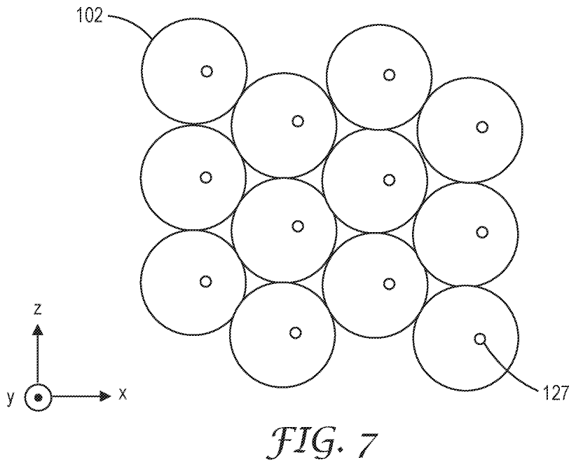

FIG. 7 is a schematic top projected view of pluralities of microlenses 102 and optical openings 127 (e.g., corresponding to first optical openings 127a or to second optical openings 127b). The microlenses 102 are arranged along orthogonal first and second directions (x- and y-directions) and the optical openings 127 are arranged along the first and second directions. In the illustrated embodiment, the microlenses 102 and optical openings 127 are on a regular triangular array. Other patterns are also possible (e.g., square or rectangular array, other periodic arrays, or irregular patterns).

In some embodiments, the optical construction or layer 100 or 200 is made by micro-replicating the plurality of microlenses 102 using a cast and ultra-violet (UV) cure process, for example, where a resin is cast on a substrate (e.g., substrate 105) and cured in contact with a replication tool surface as generally described in U.S. Pat. No. 5,175,030 (Lu et al.), U.S. Pat. No. 5,183,597 (Lu) and U.S. Pat. No. 9,919,339 (Johnson et al.), and in U.S. Pat. Appl. Publ. No. 2012/0064296 (Walker, J R. et al), for example. The mask layers (e.g., 125 or 125a and 125b) and other layers (e.g., spacer layer 129) can then be formed by coating or otherwise depositing (e.g., vapor depositing or sputtering) the layers onto to a major surface 143 of the microlens substrate opposite the first major surface 103. The openings 127 (or 127a and 127b) can then be formed by laser ablation through the microlenses 102, for example. Suitable lasers include fiber lasers such as a 40 W pulsed fiber laser operating a wavelength of 1070 nm, for example. Typically, the optically absorptive end layers of the optical cavity are ablated, while the optically transparent middle layer is substantially not ablated. Forming openings via laser ablation can result in voided regions as described further elsewhere. Creating apertures in a layer using a laser through a microlens array is generally described in US2007/0258149 (Gardner et al.), for example. Other suitable methods of forming the openings include microprinting and photolithographic techniques (e.g., including using the microlens layer to expose a photolithographic mask).

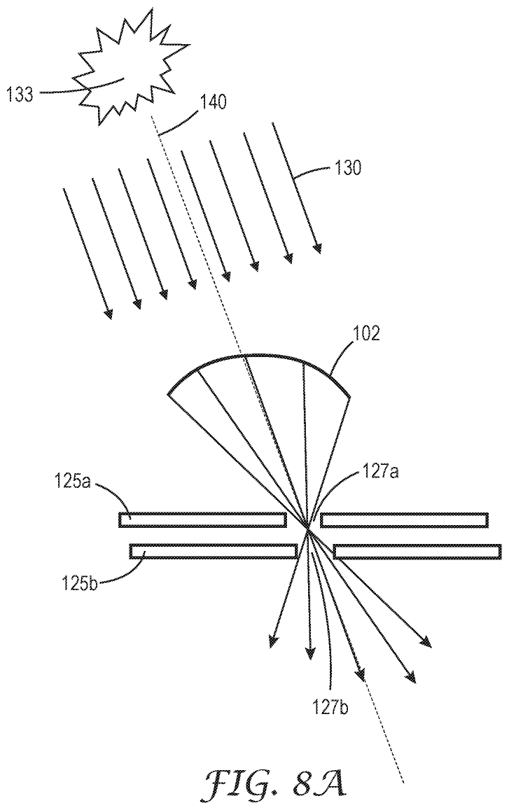

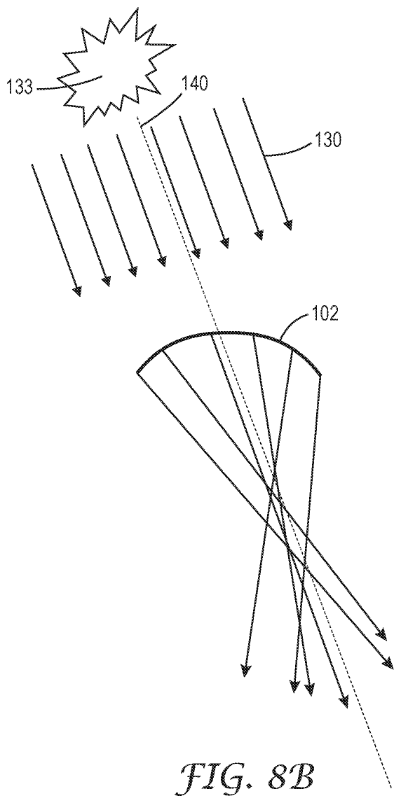

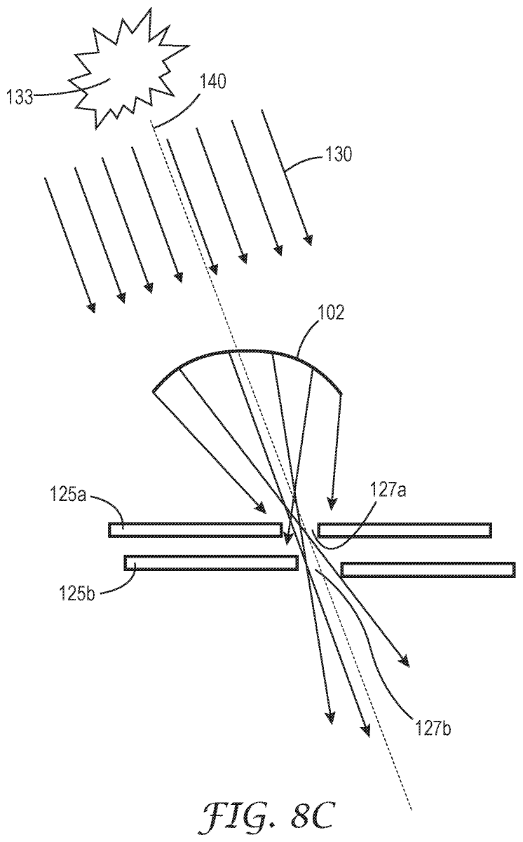

FIG. 8A is a schematic illustration of a light 130 incident on a microlens 102, according to some embodiments. FIG. 8B is a schematic illustration of a light 130 incident on a microlens 102, according to some embodiments where the microlens causes an image quality degradation. FIG. 8C is a schematic illustration of a light 130 incident on the microlens 102 where at least one of first and second optical openings 127a and 127b is sized so as to reduce an image quality degradation due to the microlens. A microlens can cause an image quality degradation, for example, when the surface of the microlens deviates from an ideal shape due to manufacturing constraints. For example, a tool used to form the microlenses may have a surface that is formed by removing material from a layer that results in a plurality of facets that approximate but do not precisely follow the ideal shape of the microlens. In some embodiments, when an image light 130 carrying an image 133 is incident on the microlens 102 (or on each microlens in at least a majority of the microlenses) along the straight line 140, where the image light 130 substantially fills the microlens 102, greater than about 35%, or greater than about 40%, or greater than about 45%, or greater than about 50% of the incident image light is transmitted by the corresponding through openings in in the first and second end layers of each of the first and second light absorbing optical cavities. In other words, in some embodiments, greater than about 35%, or greater than about 40%, or greater than about 45%, or greater than about 50% of the incident image light is transmitted by the second optical opening 127b. In some embodiments, the second mask layer 125b is omitted. In some such embodiments, greater than about 45%, or greater than about 50%, or greater than about 55%, or greater than about 60% of the incident image light is transmitted by the first optical opening 127a. In some embodiments, at least one of the first and second optical openings 127a and 127b (or at least one of the through openings 126, 128 for at least one of the light absorbing optical cavities) is sized so as to reduce an image quality degradation due to the microlens. In some embodiments where the second mask layer 125b is omitted, or in other embodiments, the first optical openings 127a (or at least one of the through openings 126, 128 for at least one of the light absorbing optical cavities of the first mask layer 125a) is sized so as to reduce an image quality degradation due to the microlens. The image light can be described as substantially filling the microlens when it fills the microlens or when it fills at least 70%, or at least 80%, or at least 90% of an area of the outer surface of the microlens, for example.

In some embodiments, for each microlens in at least a majority of the microlenses: the microlens and corresponding through openings in in the first and second end layers of each of the first and second light absorbing optical cavities are substantially centered on a straight line making a same angle with the lens layer; and when an image light carrying an image is incident on the microlens along the straight line with the image light substantially filling the microlens, at least one of the through openings corresponding to the microlens is sized so as to reduce an image quality degradation due to the microlens.

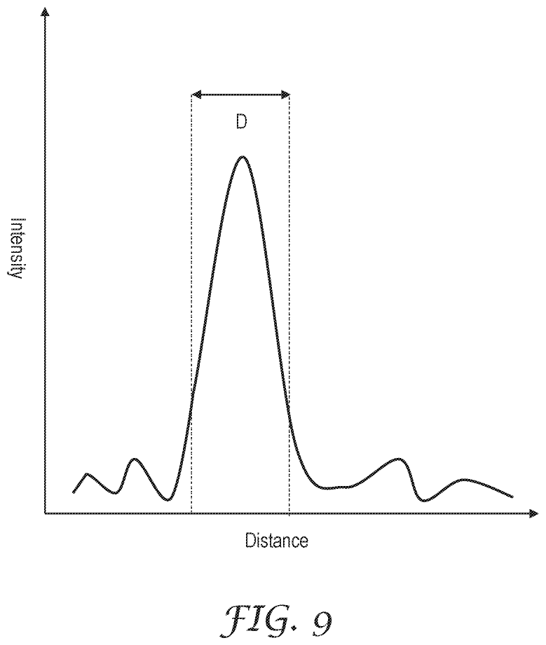

FIG. 9 is a schematic plot of an intensity distribution at a nominal image plane of light transmitted through a microlens that causes an image quality degradation. A diameter D of an opening in a mask layer that is sized so as to reduce an image quality degradation due to the microlens is illustrated. Here, the opening can refer to an optical opening through a mask and/or to through openings in end layers of a light absorbing optical cavity.

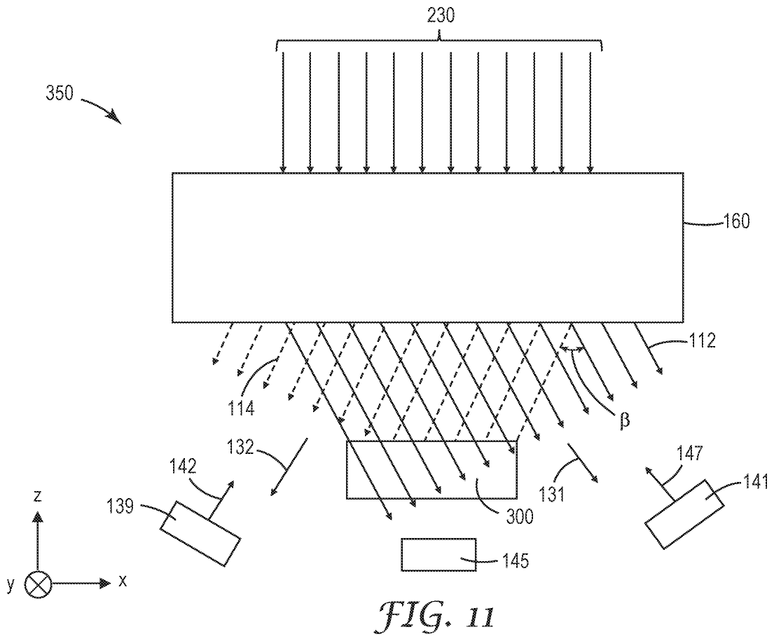

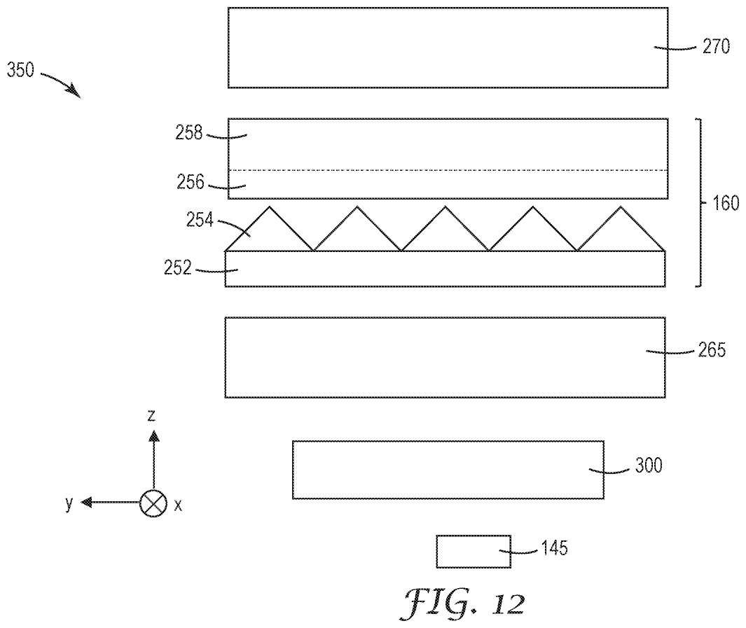

In some embodiments, the optical system is configured to detect a fingerprint. Light that propagates through the optical system from any point at the front surface of the display panel preferably has a limited spatial extent when incident on a fingerprint sensor in order to form a desired (e.g., suitably sharp) fingerprint image. This spatial extent can be quantified by the point spread function of the optical system. The larger the spatial spread of the point spread function, the blurrier is the fingerprint image. According to some embodiments, it has been found that including an optical construction described herein in the optical system can reduce a width of the point spread function. In some embodiments, the optical system has a point spread function for light incident on the optical system from a Lambertian point source that has a full width at half maximum (FWHM) at an optical sensor disposed behind the optical construction (see, e.g., FIGS. 11-12) of less than about 300 micrometers, or less than about 200 micrometers, or less than about 150 micrometers, or less than about 100 micrometers. The FWHM can be adjusted, at least in part, by a suitable selection of the diameter of the openings in the mask layer(s).

FIGS. 10A-10D are schematic cross-sectional views of regions in optical constructions or layers near an embedded end layer 122′ according to some embodiments. In some embodiments, for each first opening in at least a majority of the first openings 727 (e.g., corresponding to first optical openings 127a or to through openings in an end layer of an optical cavity), the first opening defines a voided region 723 having a maximum thickness h greater than an average thickness t4′ of the end layer 122′. The end layer 122′ can correspond to end layer 122 or end layer 121 or 121′ (see, e.g., FIGS. 1A-1D), for example. In some embodiments, the end layer 122′ has an average thickness t4′, the first openings 727 have an average largest lateral dimension d″, and t4′/d″<0.05, or t4′/d″<0.01, or t4′/d″<0.005. In some embodiments, for each first opening in the at least a majority of the first openings, the voided region 723 extending through the end layer is substantially laterally coextensive with the end layer and/or with the first opening. A voided region can be described as substantially laterally coextensive with the end layer or first opening when the voided region fills at least 60 percent (or at least 70% or at least 80% or at least 90%) of a total area of the end layer or the first opening. FIG. 10A is a schematic cross-sectional view of a portion of an optical layer that includes an end layer 122′ including openings 727 and voided regions 723 laterally coextensive with the openings 727. FIG. 10B is a schematic cross-sectional view of a portion of an optical layer that includes an end layer 122′ including openings 727 and voided regions 723 substantially laterally coextensive, but not entirely laterally coextensive, with the openings 727. A voided region is a region where solid material has been removed. Air or gas may be present in a voided region. In some embodiments, for each through opening in at least a majority of the through openings in the second end layer (e.g., 122a or 122b) of at least one of the first and second optical cavities, the through opening defines a voided region (e.g., 723a or 723c) having a maximum thickness h greater than an average thickness t4 of the second end layer. In some embodiments, the voided regions 723 have a top major surface 171 facing the first major surface 103 and an opposite bottom major surface 173 facing the second major surface 104, where in a cross-section of the optical layer substantially perpendicular to optical layer, the top and bottom surfaces have a separation h1 (see FIG. 10C) closer to a center of the voided region and a separation h2 closer to an edge of the voided region, where h1>h2. In some embodiments, h1>1.2 h2 or h1>1.5 h2. At least one of the top and bottom major surfaces can have a surface roughness R. The surface roughness R can be at least 10 nm, or at least 12 nm, or at least 15 nm, or at least 20 nm, for example. The surface roughness R can be no more than 200 nm, or no more than 150 nm, or no more than 120 nm, for example. The surface roughness can result from laser ablation of the mask layer. For example, laser ablation of the mask layer can roughen a surface of the voided region 723 by depositing nanoparticles along the surface. The surface roughness refers to the mean deviation of the surface from a mean smooth surface and may be referred to as Ra.

In some embodiments, for each first opening in at least a majority of the first openings 727, the first opening defines a voided region 723 having a top major surface 171 facing the first major surface 103 and an opposite bottom major surface 173 facing the second major surface 104. In some embodiments, as schematically illustrated in FIG. 10D, (e.g., in a cross-section of the optical layer substantially perpendicular to optical layer) the optical layer includes a plurality of nanoparticles 177 concentrated along at least one of the top and bottom major surfaces 171 and 173 of the voided regions. In some embodiments, in a cross-section of the optical layer substantially perpendicular to optical layer (e.g., in the x-z cross-section schematically illustrated in FIG. 10D), the top and bottom surfaces 171 and 173 have a separation closer to a center of the voided region greater than a separation closer to an edge of the voided region 723 (e.g., as schematically illustrated in FIG. 10A where the separation near the center is h and the separation near an edge is about t4′, or as schematically illustrated in FIG. 10C where h1>h2). At least one of the top and bottom major surfaces can have a surface roughness in a range of 10 nm to 200 nm, or in a range described elsewhere.

In some embodiments, the top and bottom surfaces 171 and 173 are substantially concave towards one another (e.g., concave toward one another along greater than 50% or at least 60% or at least 70% of an area of one or both of the surfaces).

In some embodiments, the end layer 122′ includes a first material and the nanoparticles 177 include at least one of the first material or an oxide of the first material. In some embodiments, the first material is a metal. Any suitable metal can be used for the first material. For example, the metal can be aluminum, titanium, chromium, nickel, zinc, tin, tungsten, gold, silver, indium or alloys thereof. In some embodiments, the nanoparticles include an oxide of the metal. For example, the nanoparticles can include aluminum oxide, titanium oxide, chromium oxide, zinc oxide, or combinations thereof. In some embodiments, the end layer 122′ corresponds to a second end layer 122. In some such embodiments, the first material includes aluminum, silver, indium, tin, tungsten, gold, or an alloy thereof. In some embodiments, the nanoparticles 177 are or include aluminum and aluminum oxide. In some embodiments, the nanoparticles 177 include aluminum oxide at greater than about 50 weight percent.

In some embodiments, at least 90% of the nanoparticles 177 have an average diameter less than about 150 nm, or less than about 100 nm. In some embodiments, at least 90% of the nanoparticles have an average diameter greater than about 1 nm, or greater than about 5 nm, or greater than about 10 nm. The average diameter of a nanoparticle is the diameter of a sphere having a volume equal to that of the nanoparticle.

In some embodiments, an optical construction includes a first mask layer 125a defining a plurality of first optical openings 127a therethrough and a second mask layer 125b defining a plurality of second optical openings 127b therethrough. In some embodiments, for each first optical opening in at least a majority of the first optical openings, the first optical opening defines voided region(s) (e.g., through one or both end layers of a light absorbing optical cavity included in the first mask layer). In some such embodiments, or in other embodiments, for each second optical opening in at least a majority of the second optical openings, the second optical opening defines voided region(s) (e.g., through one or both end layers of a light absorbing optical cavity included in the second mask layer).

In some embodiments, for each through opening in at least a majority of the through openings (e.g., 128) in the second end layer (e.g., 122a or 122b) of at least one of the first and second optical cavities, the through opening defines a voided region 723 having a top major surface 171 facing the lens layer 110 and an opposite bottom major surface 173. In some embodiments, in a cross-section of the optical construction substantially perpendicular to optical construction, the optical construction includes a plurality of nanoparticles 177 concentrated along at least one of the top and bottom major surfaces 171 and 173 of the voided regions. In some embodiments, in a cross-section of the optical construction substantially perpendicular to optical construction, the top and bottom surfaces have a separation closer to a center of the voided region greater than a separation closer to an edge of the voided region, and at least one of the top and bottom major surfaces has a surface roughness in a range of 10 nm to 200 nm.

In one example, an optical layer included a microlens array and two embedded 30 nm thick aluminum layers. Through holes in the aluminum layers were formed by laser ablation using a 40 W SPI laser (available from SPI Lasers, Southampton, UK) at 50% power with a 7× expander installed, a 167 mm F-Theta lens, a 30 nm pulse length, a 20 kHz repetition rate, a 2 m/s scanning speed, and a 100 micrometer spacing. Approximately 120 nm thick sections of the resulting optical layer were microtomed from the sample. A voided region or gas pocket resulting from the ablation process was visible in an image of the microtomed sample. The voided region had a maximum thickness greater than the thickness of the aluminum layer. A High-Angle Annular Dark-Field (HAADF) image of a section through an opening in the aluminum layer facing the microlens layer showed nanoparticles at opposing surfaces of the voided region at the opening. STEM-EDS (Scanning Transmission Electron Microscope-Energy-Dispersive Spectroscopy) analysis indicated that the nanoparticles were composed mostly of aluminum and oxygen.

In some embodiments, an integral optical layer (e.g., optical construction or layer 200) includes a first polymeric layer disposed between the first major surface 103 and the mask layer, and a second polymeric layer disposed between the mask layer and the second major surface 104. In some embodiments, at least one of the first and second polymeric layers includes a plurality of second nanoparticles dispersed uniformly therein. For example, the second nanoparticles can be included to increase the refractive index of the layer as is known in the art (see, e.g., U.S. Pat. No. 8,202,573 (Pokorny et al.)).

FIG. 11 is a schematic illustration of an optical system 350 according to some embodiments. FIG. 12 is a schematic illustration of some embodiments of the optical system 350.

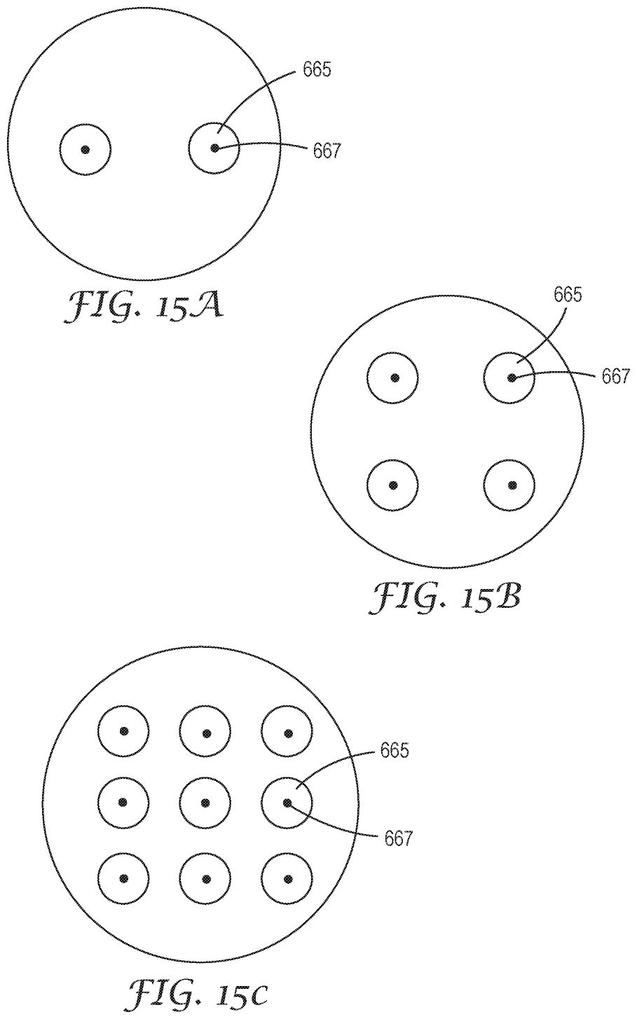

In some embodiments, an optical system 350 includes an optical construction 300 (e.g., corresponding to any of the optical constructions or optical layers described herein) and a refractive component 160. The optical construction 300 includes a lens layer 110 including a plurality of microlenses arranged along orthogonal first and second directions (x- and y-directions), and an optically opaque first mask layer 125a spaced apart from the lens layer 110 and defining a plurality of first optical openings therein arranged along the first and second directions. In some embodiments, there is a one-to-one correspondence between the microlenses and the first openings, such that for each microlens, the microlens and corresponding first opening are substantially centered on a straight line 140, where each straight line makes a same oblique angle θ with the lens layer 110. In some embodiments, the refractive component 160 extends along the first and second directions and is disposed proximate the optical construction such that for at least one first light beam 230 incident on the refractive component along a third direction (−z-direction) substantially orthogonal to the lens layer (e.g., within 30 degrees, or within 20 degrees, or within 10 degrees of orthogonal to the plane of the lens layer), the refractive component 160 splits the first light beam into 2 to 9 beam segments 665 (see FIGS. 15A-15C) exiting the refractive component along respective 2 to 9 primary directions 667 (see FIGS. 15A-15C), where a first primary direction 131 in the 2 to 9 primary directions is substantially parallel (e.g., within 30 degrees, or within 20 degrees, or within 10 degrees of parallel) to each straight line 140. The beam segments and primary directions can be identified from a conoscopic plot of the transmitted light intensity, for example, as described further elsewhere herein (see, e.g., FIGS. 15A-15C).

In some embodiments, the optical construction 300 further includes an optically opaque second mask layer 125b spaced apart from the lens and first mask layers 110 and 125a and defining a plurality of second optical openings 127b therein arranged along the first and second directions, with the first mask layer 125a disposed between the lens and second mask layers 110 and 125b (see, e.g., FIG. 4A). In some embodiments, there is a one-to-one correspondence between the microlenses and the second openings, such that for each microlens 102a and corresponding straight line 140a, the microlens 102a and corresponding first and second openings 127a′ and 127b′ are substantially centered on the straight line 140a.

In some embodiments, the optical system 350 further includes a photosensor 225 adjacent the optical construction 300 (see, e.g., FIG. 6). As described further elsewhere herein, the photosensor 225 can include a plurality of sensor pixels. There can be a one-to-one correspondence between the microlenses and the sensor pixels, such that for each microlens and corresponding straight line, the microlens and corresponding first openings and sensor pixels are substantially centered on the straight line 140.

In some embodiments, for each microlens in at least a majority of microlenses in the plurality of microlenses, at least two of the beam segments 112, 114 are incident on the microlens, where the at least two of the beam segments 112, 114 include a first beam segment 112 propagating along the first primary direction 131. In some embodiments, at least 30%, or at least 40%, or at least 45%, or at least 50%, or at least 55% of light in the beam segments that is incident on the optical construction 300 along the first primary direction 131, but not any other primary direction, is transmitted through the optical construction 300. In some embodiments, for each primary direction 132 except for the first primary direction 131, no more than 10%, or no more than 5% of light in the beam segment that is incident on the optical construction 300 along the primary direction is transmitted through the optical construction.

In some embodiments, an optical system 350 includes a refractive component 160 extending along orthogonal first and second directions such that for at least one first light beam 230 incident on the refractive component 160 along a third direction substantially orthogonal to the first and second directions, the refractive component splits the first light beam into 2 to 9 beam segments exiting the refractive component along respective 2 to 9 primary directions, where the 2 to 9 primary directions include a first primary direction 131. In some embodiments, the 2 to 9 primary directions define angles β therebetween, where each angle β is greater than about 30 degrees. In some embodiments, the refractive component 160 includes a first prism film 252 including a first plurality of prisms 254 extending along a first longitudinal direction (e.g., x-direction) substantially parallel to the lens layer 110 or substantially parallel to a plane defined by the first and second directions (e.g., x- and y-directions). In some embodiments, the refractive component 160 further includes a second prism film 256 adjacent the first prism film 252. The second prism film 256 can include a second plurality of prisms 258 extending along a second longitudinal direction (e.g., y-direction) substantially parallel to the lens layer 110 or substantially parallel to a plane defined by the first and second directions (e.g., x- and y-directions) and substantially orthogonal to the first longitudinal direction.

The optical system 350 can further include an optical construction 300 disposed proximate the refractive component 160 such that at least 45% of light (or any of the ranges described elsewhere herein) in the beam segment that is incident on the optical construction 300 along the first primary direction 131, but not any other primary direction 132, is transmitted through the optical construction 300. The optical system 350 can further include a light source 139 and/or 141 disposed to emit light 142 and/or 147, respectively, along a direction substantially parallel to a second primary direction in the 2 to 9 primary directions. In some embodiments, the light source is an infrared light source. In some embodiments, the optical system 350 includes an infrared diffuser. For example, an infrared diffuser can be positioned between an infrared light source and the touch surface of the display to improve the uniformity of the infrared light incident on the touch surface. The optical system 350 can further include an optical sensor 145 disposed to receive light transmitted through the optical construction 300 along the first primary direction 131. In some embodiments, the optical sensor 145 is an infrared light sensor. In some embodiments, the first and second primary directions are different (e.g., the first primary direction can be direction 131 and the second primary direction can be direction 132). In some embodiments, the first and second primary directions are the same (e.g., the first and second primary directions can each be direction 131).

In some embodiments, the optical system 350 includes a liquid crystal display 270 extending along the first and second directions, a lightguide 265 disposed to illuminate the liquid crystal display, a refractive component 160 disposed between the liquid crystal display 270 and the lightguide 265 where the refractive component includes (at least) a first prism film including a first plurality of prisms extending along a first longitudinal direction substantially parallel (e.g., within 30 degrees, or within 20 degrees, or within 10 degrees of parallel) to a plane defined by the first and second directions; and an optical sensor 145 disposed proximate the lightguide 265 opposite the liquid crystal display 270. In some embodiments, an optical construction 300 is disposed between the lightguide 265 and the optical sensor 145 such that the microlenses 102 face away from the optical sensor 145 (e.g., the optical construction of any of FIG. 2A to 4A or 5 may be placed as indicated in FIG. 11 for optical construction 300 oriented as indicated by the x-y-z coordinate systems of FIG. 2A to 4A or 5 and 11).

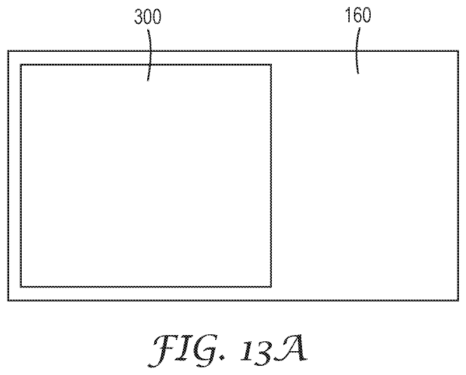

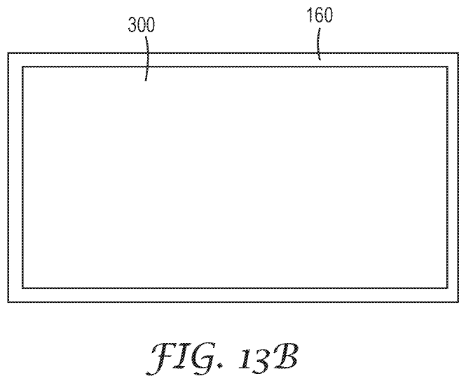

FIGS. 13A-13B are schematic views of maximum projected areas of the optical construction 300 and the refractive component 160 according to some embodiments. As schematically illustrated in FIG. 13A, in some embodiments, the optical construction 300 is substantially coextensive with at least a portion of the refractive component 160, where the portion of the refractive component 160 has a maximum projected area of at least about 30% of a maximum projected area of the refractive component 160. As schematically illustrated in FIG. 13B, in some embodiments, the optical construction 300 and the refractive component 160 are substantially coextensive. A layer or surface can be substantially coextensive with another layer or surface when at least 60% or at least 70% or at least 80% or at least 90% of a total area of the layer or surface is coextensive with at least 60% or at least 70% or at least 80% or at least 90%, respectively, of a total area of the other layer or surface.

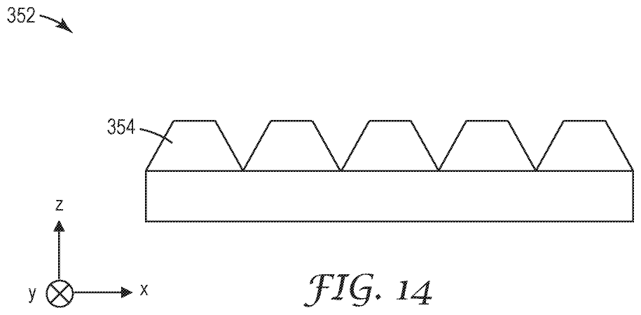

The number of primary directions can be determined by the number and shape of light redirecting films, for example, included in the refractive component 160. For example, at least one first light beam (e.g., a substantially normally incident light beam having a diameter larger than a prism width) incident on a single prism film will result in two primary directions, while the first light beam incident on crossed prism films will result in four primary directions. FIG. 14 is a schematic cross-sectional view of a truncated prism film 352 which includes a plurality of truncated prisms 354 arranged along a first direction (x-direction) and extending along an orthogonal second direction (y-direction). At least one first light beam incident on the film 352 will be split into 3 beam segments, one for each facet of the truncated prisms 354. More generally, n non-vertical facets can result inn beam segments. Two crossed truncated prism films 352 will result in 9 primary directions. In some embodiments, the 2 to 9 primary directions are 2, 4, or 9 primary directions. In some embodiments, the 2 to 9 primary directions are 4 primary directions.

FIGS. 15A-15C are conoscopic plots illustrating beam segments 665 and primary directions 667. Each point in a conoscopic plot represents a direction (specified by an azimuthal angle and a polar angle). The darker regions indicate higher intensity of transmitted light. The beam segment 665 are higher intensity regions representing light beams propagating primarily along primary directions 667 which can be taken to be the directions where the intensity has a local maximum. In FIG. 15A, there are two beam segments 665 propagating in two primary directions 667; in FIG. 15B, there are four beam segments 665 propagating in four primary directions 667; and in FIG. 15C, there are nine beam segments 665 propagating in nine primary directions 667.

In some embodiments, the microlens layer is bonded to a display panel through a low index layer. In some embodiments, the low index layer has a refractive index of no more than 1.3 (e.g., in a range of 1.1 to 1.3) and is disposed on and has a major surface substantially conforming to the first major surface 103 of the lens layer 110. Refractive index refers to the refractive index at 633 nm unless indicated otherwise. Layers having a refractive index of no more than 1.3 may be nanovoided layers as described in U.S. Pat. Appl. Publ. Nos. 2013/0011608 (Wolk et al.) and 2013/0235614 (Wolk et al.), for example.

In some embodiments, the lens layer 110 further includes optical decoupling structures which may be disposed between adjacent microlenses. The optical decoupling structures can be any objects which protrude beyond the microlenses for attachment to an adjacent layer such that the adjacent layer does not contact the microlenses. The optical decoupling structures can be cylindrical posts or can be posts having a non-circular cross-section (e.g., rectangular, square, elliptical, or triangular cross-section). The optical decoupling structures can have a constant cross-section, or the cross-section can vary in the thickness direction (e.g., the optical decoupling structures can be posts which are tapered to be thinner near the top of the posts). In some embodiments, the optical decoupling structures have a tapered elliptical cross-section. For example, the optical decoupling structures can have any of the geometries of the optical decoupling structures described in International Appl. Pub. No. WO 2019/135190 (Pham et al.). In some embodiments, the optical decoupling structures extend from a base of the array of microlenses. In some embodiments, at least some optical decoupling structures are disposed on top of at least some of the microlenses. Related optical constructions including optical decoupling structures are described in International Appl. Pub. No. WO 2020/035768 (Yang et al.) and in U.S. Appl. No. 62/944,676 filed Dec. 6, 2019 and titled “Optical Layer and Optical System”.

In some embodiments, an optical construction or layer includes two pluralities of microlenses. For example, an optical construction or layer can have opposite first and second major surfaces each including a plurality of microlenses. The optical construction or layer can further include an embedded optically opaque mask layer disposed between and spaced apart from the first and second major surfaces. The mask layer can include a light absorbing optical cavity as described further elsewhere herein. Related optical constructions including opposing microlens layers are described in International Appl. Pub. No. WO 2020/035768 (Yang et al.) and in U.S. Appl. No. 62/944,676 filed Dec. 6, 2019 and titled “Optical Layer and Optical System”.

### Examples

Optical modeling was carried out to determine the reflectance of an optical construction generally as shown in FIG. 3B for optical construction 700′ for light substantially normally incident on the lens layer side of the optical construction away from the optical openings 127a and 127b. The lenses 102 were taken to be formed from an acrylate and the substrate was modeled as a 23.4 micrometer thick layer of polyethylene terephthalate (PET). The layer 923 was modeled as acrylate layer having a thickness of 100 nm. The layer 123a was also modeled as an acrylate layer and the layer 124a was modeled has having a same refractive index as layer 123a. The total thickness t1 of the layers 123a and 124a was varied from 60 nm to 100 nm. In some examples, the end layer 121a was modeled as a titanium layer having a thickness in a range of 8 nm to 16 nm. In some examples, the end layer 121a was modeled as formed from 5.5 nm of Cr, or 10.5 nm of Ni, or 8.4 nm of NiCr, or 14.4 nm of Al, or 52 nm of Ag. The layer 122a was modeled as aluminum sufficiently thick that the transmittance through the layer was less than 0.05% at visible wavelengths. Since the transmission through this layer was negligible, the layers below layer 122a in FIG. 3B were not modeled.

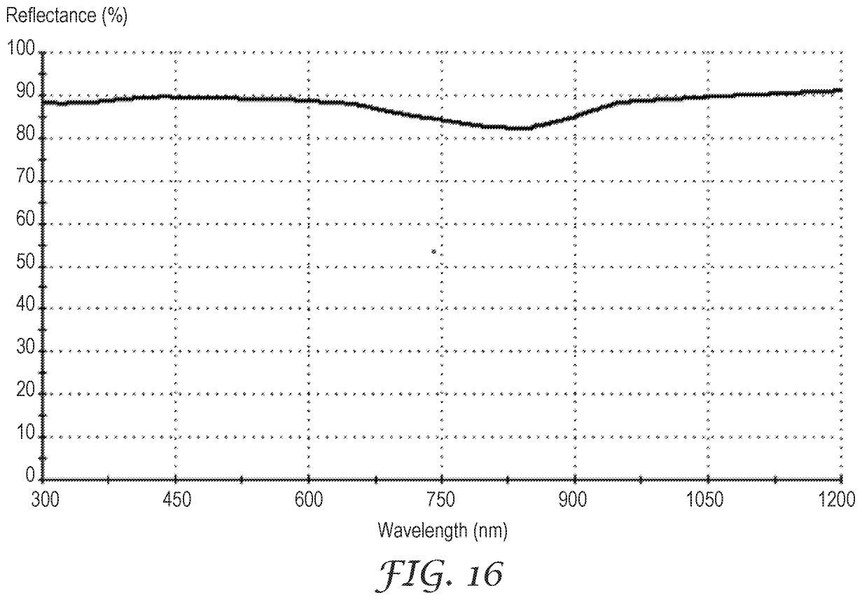

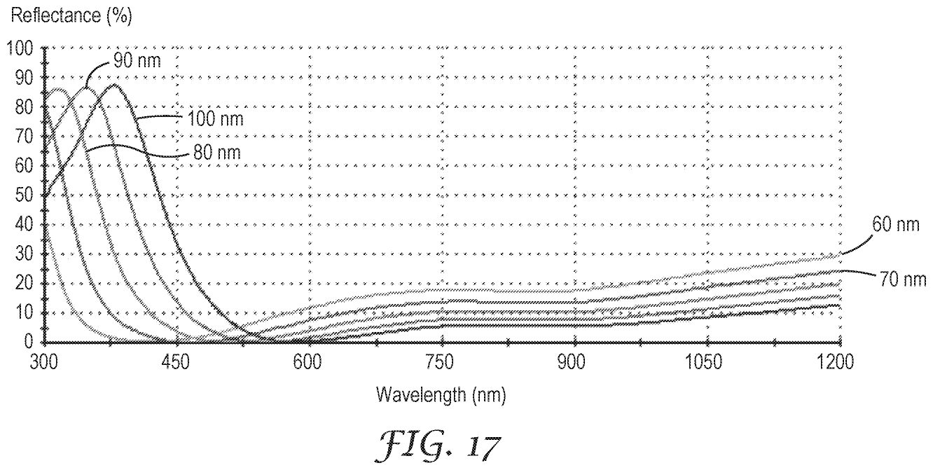

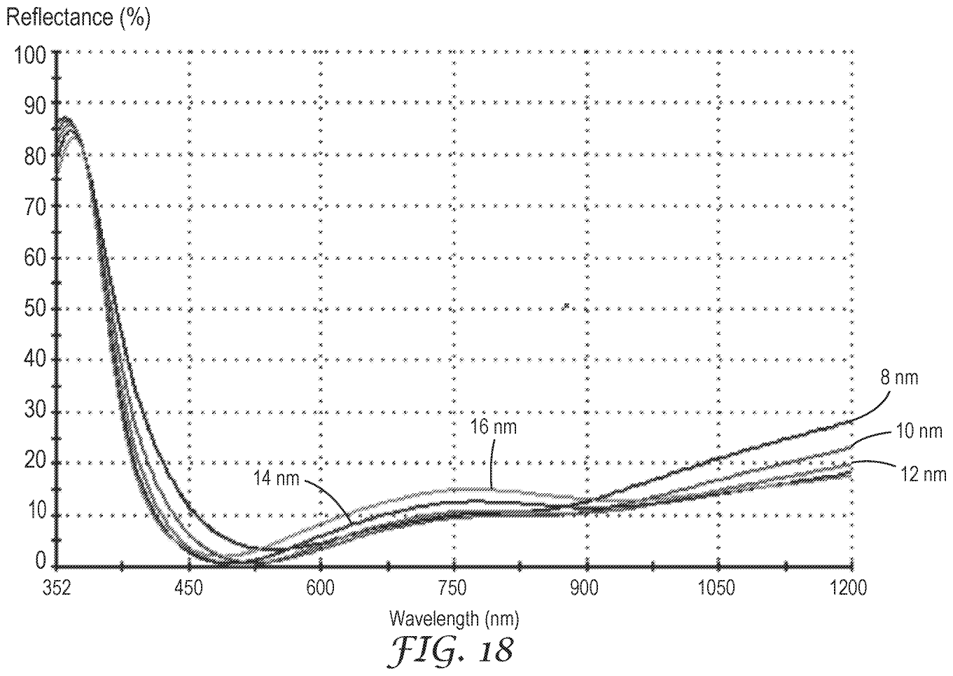

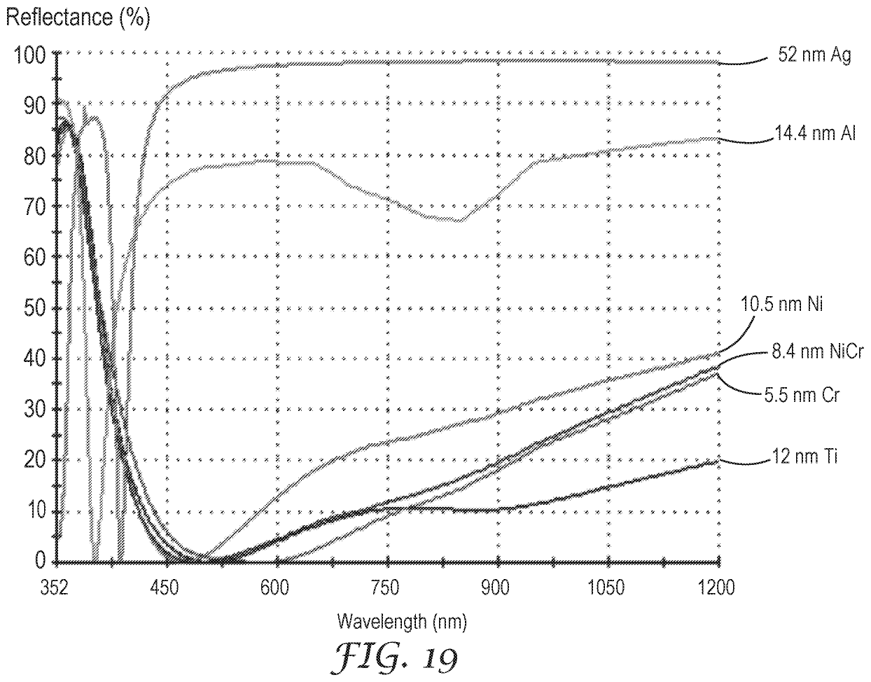

FIG. 16 shows the calculated reflectance versus wavelength for a comparative optical construction where the mask layers were aluminum layers an no light absorbing optical cavity was included. FIG. 17 shows the calculated reflectance versus wavelength when the layer 121a was a 12 nm thick titanium layer and the thickness t1 varied from 60 nm to 100 nm as indicated on the plot. FIG. 18 shows the calculated reflectance versus wavelength when the thickness t1 was 80 nm and the layer 121a was a titanium layer having a thickness in a range of 8 nm to 16 nm as indicated on the plot. FIG. 19 shows the calculated reflectance versus wavelength when the thickness t1 was 80 nm and the layer 121a was a metal layer of the type and thickness indicated on the plot.

Optical modeling using LightTools ray tracing software (available from Synopsis, Inc., Mountain View, CA) was carried out as follows. A Lambertian point source was used to represent a fingerprint. In the model, crossed prism films were placed between the point source and an image sensor, an LCD display panel was placed between the point source and the crossed prism films, and an optical element similar to optical element or layer 100 or 200 was placed between the crossed prism films and the image sensor with the microlenses facing the crossed prism films and the mask layer(s) facing the image sensor. The optical openings were positioned such that light incident on the microlenses at 52 degrees relative to a normal to the plane of the optical element would pass through the optical element. Model parameters were as follows: the LCD panel thickness was 0.5 mm; the distance from the point source to the optical element was 1 mm; the radius of curvature of the microlenses was 25 micrometers; the distance from the top of microlens layer to the first mask layer was 32 micrometers; when two mask layers was included, the spacing between the two mask layers was 5 micrometers; the through opening diameter was 3 micrometers; and the refractive index of the microlenses was 1.65. Each mask layer was modeled as a perfect optical absorber or, equivalently, the light absorbing optical cavities of the mask layers (e.g., corresponding to optical cavities 120a to 120d) were modeled as perfectly light absorbing.

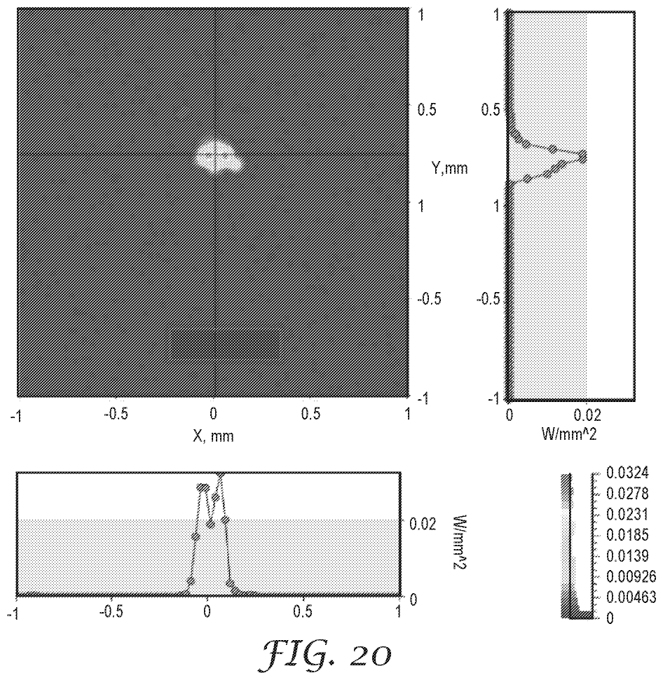

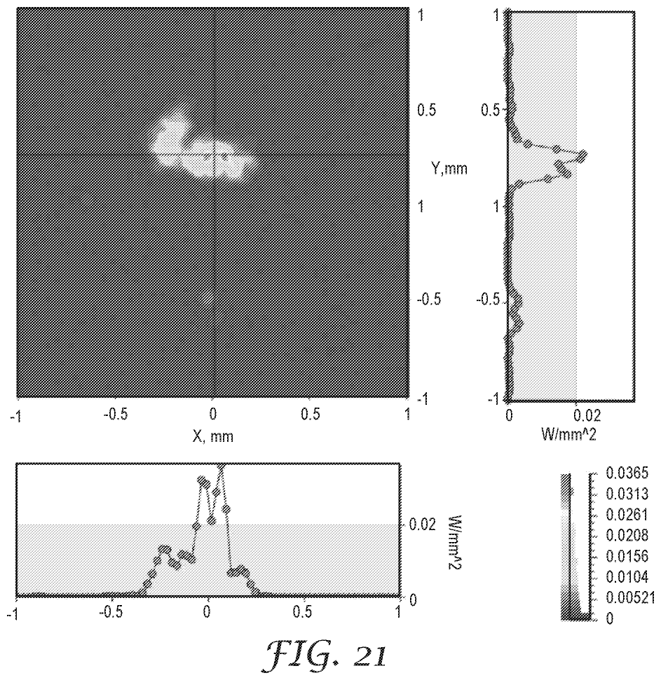

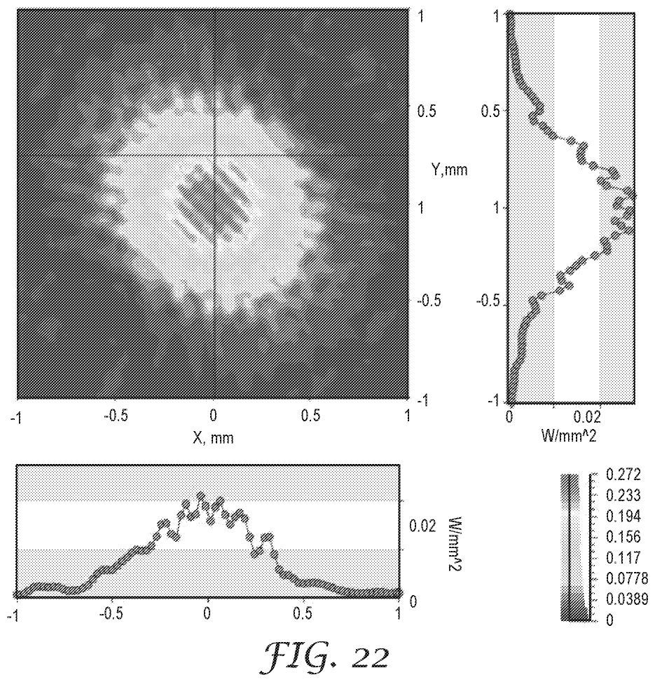

FIGS. 20-22 show the point spread function determined for the case where the optical element included two mask layers (FIG. 20), for the case where the optical element included only one mask layer (FIG. 21), and for the case where the optical element was omitted (FIG. 22). The width of the point spread function was significantly reduced when an optical element was included compared to the case where the optical element was omitted. Including two mask layers significantly reduced the point spread function compared to the case where a single mask layer was used.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1-15. (canceled)

16. An optical construction comprising:
a lens layer comprising a plurality of microlenses formed on a substrate and arranged along orthogonal first and second directions;
first and second light absorbing optical cavities disposed on the substrate side of the lens layer, each light absorbing optical cavity having an average thickness of less than about 300 nm and comprising an optically transparent middle layer disposed between light absorbing first and second end layers, each of the first and second end layers, but not the middle layer, defining a plurality of through openings therein arranged along the first and second directions and aligned in a one-to-one correspondence with the microlenses; and
an optically transparent spacer layer disposed between the first and second light absorbing optical cavities and having an average thickness of greater than about 1 micrometer.

17. The optical construction of claim 16, wherein the light absorbing first end layer of each of the first and second light absorbing optical cavities comprises titanium, chromium, nickel, or an alloy thereof.

18. The optical construction of claim 16, wherein the light absorbing first end layer of each of the first and second light absorbing optical cavities comprises titanium and has an average thickness of less than about 25 nm.

19. The optical construction of claim 16, wherein the light absorbing second end layer of each of the first and second light absorbing optical cavities comprises aluminum, silver, indium, tin, tungsten, gold, or an alloy thereof.

20. The optical construction of claim 16, wherein the light absorbing second end layer of each of the first and second light absorbing optical cavities comprises aluminum and has an average thickness of less than about 50 nm.

21. The optical construction of claim 16, wherein the middle layer is a polymeric layer and at least one of the first and second light absorbing optical cavities further comprises an alloy of the second end layer disposed between the first end layer and the middle layer.

22. The optical construction of claim 16, wherein the second end layers of the first and second light absorbing optical cavities face each other, and the first end layers of the first and second light absorbing optical cavities face away from each other.

23. The optical construction of claim 16, further comprising third and fourth light absorbing optical cavities disposed on the substrate side of the lens layer, the optically transparent spacer layer being disposed between the third and fourth light absorbing optical cavities, wherein for each of the third and fourth light absorbing optical cavities, the optical cavity has an average thickness of less than about 300 nm and comprises an optically transparent middle layer disposed between light absorbing first and second end layers, each of the first and second end layers, but not the middle layer, defining a plurality of through openings therein arranged along the first and second directions and aligned in a one-to-one correspondence with the microlenses.

24. The optical construction of claim 16, wherein for each microlens in at least a majority of the microlenses:
the microlens and corresponding through openings in in the first and second end layers of each of the first and second light absorbing optical cavities are substantially centered on a straight line making a same angle with the lens layer; and
when an image light carrying an image is incident on the microlens along the straight line, the image light substantially filling the microlens, at least one of the through openings corresponding to the microlens is sized so as to reduce an image quality degradation due to the microlens.

25. The optical construction of claim 16, wherein for each through opening in at least a majority of the through openings in the second end layer of at least one of the first and second optical cavities, the through opening defines a voided region having a top major surface facing the lens layer and an opposite bottom major surface, and wherein in a cross-section of the optical construction substantially perpendicular to optical construction, the optical construction comprises a plurality of nanoparticles concentrated along at least one of the top and bottom major surfaces of the voided regions.

26. An optical system comprising:
the optical construction of claim 16;
a liquid crystal display extending along the first and second directions;
a lightguide disposed to illuminate the liquid crystal display;
a refractive component disposed between the liquid crystal display and the lightguide, the refractive component comprising a first prism film comprising a first plurality of prisms extending along a first longitudinal direction substantially parallel to a plane defined by the first and second directions; and
an optical sensor disposed proximate the lightguide opposite the liquid crystal display, wherein the optical construction is disposed between the lightguide and the optical sensor such that the microlenses face away from the optical sensor.

27. An optical construction comprising:
a lens layer comprising a plurality of microlenses arranged along orthogonal first and second directions;
an optically opaque first mask layer spaced apart from the lens layer and defining a plurality of first optical openings therethrough arranged along the first and second directions, the first mask layer comprising a first light absorbing optical cavity having an average thickness of less than about 300 nm and comprising an optically transparent middle layer disposed between light absorbing first and second end layers, each first optical opening comprising a through opening in each of the first and second end layers, but not in the middle layer; and
an optically opaque second mask layer spaced apart from the lens and first mask layers and defining a plurality of second optical openings therethrough arranged along the first and second directions, the first mask layer disposed between the lens and the second mask layers, there being a one-to-one correspondence between the microlenses and the first and second optical openings, such that for each microlens, the microlens and corresponding first and second optical openings are substantially centered on a straight line making a same angle with the lens layer, wherein when an image light carrying an image is incident on the microlens along the straight line, the image light substantially filling the microlens, at least one of the first and second optical openings is sized so as to reduce an image quality degradation due to the microlens.

28. An optical system comprising:
the optical construction of claim 27;
a liquid crystal display extending along the first and second directions;
a lightguide disposed to illuminate the liquid crystal display;
a refractive component disposed between the liquid crystal display and the lightguide, the refractive component comprising a first prism film comprising a first plurality of prisms extending along a first longitudinal direction substantially parallel to a plane defined by the first and second directions; and
an optical sensor disposed proximate the lightguide opposite the liquid crystal display, wherein the optical construction is disposed between the lightguide and the optical sensor such that the microlenses face away from the optical sensor.

29. An optical construction comprising an integral optical layer, the integral optical layer comprising:
a structured first major surface and an opposite second major surface, the structured first major surface defining a plurality of microlenses arranged along orthogonal first and second directions; and
an embedded optically opaque first mask layer disposed between and spaced apart from the first and second major surfaces, the first mask layer defining a plurality of first optical openings therethrough arranged along the first and second directions, there being a one-to-one correspondence between the microlenses and the first optical openings, wherein for each first optical opening in at least a majority of the first optical openings, the first optical opening defines a first voided region having a top major surface facing the first major surface and an opposite bottom major surface facing the second major surface, wherein in a cross-section of the integral optical layer substantially perpendicular to the integral optical layer, the top and bottom major surfaces have a separation closer to a center of the first voided region greater than a separation closer to an edge of the first voided region, and wherein the first mask layer comprises a light absorbing optical cavity having an average thickness of less than about 300 nm and comprising an optically transparent middle layer disposed between light absorbing first and second end layers, each first optical opening comprising a through opening in each of the first and second end layers, but not in the middle layer.

30. The optical construction of claim 29, wherein for each first optical opening in the at least the majority of the first optical openings:
the first voided region extends through a thickness of the second end layer; and
the first optical opening defines a second voided region extending through a thickness of the first end layer.

31. The optical construction of claim 29, wherein in the cross-section of the integral optical layer substantially perpendicular to the integral optical layer, the integral optical layer comprises a plurality of nanoparticles concentrated along at least one of the top and bottom major surfaces of the first voided regions.

32. An optical system comprising:
the optical construction of claim 29;
a liquid crystal display extending along the first and second directions;
a lightguide disposed to illuminate the liquid crystal display;
a refractive component disposed between the liquid crystal display and the lightguide, the refractive component comprising a first prism film comprising a first plurality of prisms extending along a first longitudinal direction substantially parallel to a plane defined by the first and second directions; and
an optical sensor disposed proximate the lightguide opposite the liquid crystal display, wherein the optical construction is disposed between the lightguide and the optical sensor such that the microlenses face away from the optical sensor.
